(19) United States
(12) Patent Application Publication
(10) Pub. No.: US 2019/0233345 A1
(43) Pub. Date: Aug. 1, 2019

(54) AGRICULTURAL SYSTEMS, COMPOSITIONS AND METHODS FOR INCREASING CROP YIELD

(71) Applicants: E. I. DU PONT DE NEMOURS AND COMPANY, Wilmington, DE (US); PIONEER HI-BRED INTERNATIONAL, INC., Johnston, IA (US)

(72) Inventors: MARIOS AVGOUSTI, KENETT SQUARE, PA (US); ROBERT RAY BURCH, EXTON, PA (US); TIMOTHY CASPAR, YORKLYN, DE (US); JASON DEBRUIN, MACOMB, IL (US); JOHN D. EVERARD, GRIMES, IA (US); RAJEEV L. GOROWARA, WILMINGTON, DE (US); DARREN B. GRUIS, BAXTER, IA (US); RAFAEL HERRMANN, WILMINGTON, DE (US); SHANE FRANCIS KENDRA, ALDAN, PA (US); KATRINA KRATZ, CHADDS FORD, PA (US); JACY CAMERON MACCHIA, PHILADELPHIA, PA (US); RYAN ARTHUR PAPE, CORALVILLE, IA (US); JEFFREY R. SCHUSSLER, MARION, IA (US); NING WANG, WILMINGTON, DE (US); JIHUA ZHANG, GARNET VALLEY, PA (US)

(73) Assignees: E. I. DU PONT DE NEMOURS AND COMPANY, WILMINGTON, DE (US); PIONEER HI-BRED INTERNATIONAL, INC., JOHNSTON, IA (US)

(21) Appl. No.: 16/087,520

(22) PCT Filed: Mar. 22, 2017
(86) PCT No.: PCT/US2017/023524

§ 371 Date: Sep. 21, 2018

Related U.S. Application Data
(60) Provisional application No. 62/311,911, filed on Mar. 23, 2016.

(51) Int. Cl. C05G 3/00; C05G 3/02; C05C 9/00; C05C 3/00; C05D 1/00; C05B 17/00; A01N 43/56; A01C 7/06; A01C 7/08

(52) U.S. Cl. CPC C05G 3/0029; C05G 3/02; C05C 9/00; C05C 3/00; A01C 7/08; C05B 17/00; A01N 43/56; A01C 7/06; C05D 1/00

(57) ABSTRACT

The disclosure relates to systems, compositions and methods for providing nutrients, fertilizers, crop protection agents and other crop inputs for a plant. The disclosure also relates to methods for increasing the uptake of a crop active compound into a growing plant.

### FIELD

The disclosure relates to systems, compositions and methods for providing nutrients, fertilizers, crop protection agents and other crop inputs for a plant.

### BACKGROUND

Current commercial agricultural practices apply a large amount of fertilizer, especially nitrogen fertilizers, to the soil prior to, during, or shortly after the planting of a propagule. Significant amounts of fertilizer are lost due to volatilization and leaching. The leaching and other losses reduce the net amount of the fertilizer that is available to a growing plant thereby reducing yield, especially for those crops that depend on late-season nitrogen for yield increase.

Additionally, pressure from pests and disease causing agents can require multiple applications of pesticides and other crop protection actives such as insecticides, fungicides and nematicides. Late season pest pressure is generally difficult to control effectively in large fields where the entry of the application equipment within the field may injure growing plants and may require multiple passes for effective control.

There is a need to improve the delivery of fertilizer, pesticides and other crop protection materials to crops such that the appropriate amount of such crop inputs are available at the appropriate stage of a crop's development and pest pressure.

### SUMMARY

A fertilizer composition includes a fertilizer core comprising from about 0.1 to 0.8 grams of nitrogen; and a polymer layer surrounding the fertilizer core; wherein the polymer layer has a water permeability of about 1 to about 2000 g/m2/day at 25 degrees Celsius and wherein the fertilizer composition is configured to be placed in a field at a predetermined distance from a row crop seed whereby the fertilizer composition delivers an effective amount of nitrogen during late growth stages of row crop development, such as for example, late vegetative growth stages or the reproductive growth stages of the row crop when nitrogen demand and uptake is higher.

An agricultural composition includes a fertilizer core; and a layer of a polymer surrounding the fertilizer core; wherein the agricultural composition has a water permeability of about 1 to about 2000 g/m2/day at 25 degrees Celsius; and wherein the fertilizer composition is between about 6 and 14 mm in diameter.

In an embodiment, the fertilizer composition has an aspect ratio of between about 1 and 3. In an embodiment, the fertilizer composition is in the form of a sphere. In an embodiment, the fertilizer composition is in a non-spherical form. In an embodiment, the fertilizer composition is in the form of a cylinder. In an embodiment, the cylinder comprises either flat or rounded ends. In an embodiment, the fertilizer composition is in the form of a briquette. In an embodiment, the fertilizer composition is in the form of a mono-dispersed composition, e.g., a sphere.

In an embodiment, the fertilizer composition is configured to flow through a seed planter. In an embodiment, the seed planter moves at a speed about 5-15 mph and the agricultural composition is planted at a density of about 10,000 to about 300,000/acre, wherein each of the agricultural composition comprises about 100-500, 500, 600, 700 mg of nitrogen.

In an embodiment, the polymer layer is a biodegradable aliphatic polyester. In an embodiment, the polyester is polylactic acid comprising a weight averaged molecular weight of about 20 kDa to about 150 kDa. In an embodiment, the polymer layer is about 0.3 mil to about 10.0 mil thick. In an embodiment, the polymer layer constitutes about 0.5% or 2% to no more than about 10% of the total weight (or amount) of the fertilizer composition.

In an embodiment, the fertilizer composition has a release profile of about 15-25% cumulative N release in a crop growing field by about 40 days after planting. In an embodiment, the cumulative N release is about 50-100%, 60%, 70%, 80%, 90% and 100% in a maize growing field by about 50-90, 60, 70, 80, 90 and 100 days after planting.

In an embodiment, the fertilizer composition has a hardness parameter between about 50N to about 500N. In an embodiment, the hardness parameter is about 100N.

A method of producing an extended-release fertilizer composition, the method includes providing a fertilizer core having a size aspect ratio of between about 1 and 3; placing the fertilizer core in a polymer layer film, wherein the polymer layer comprises a thickness of about 0.3 mil to about 10.0 mil; and applying force such that the polymer layer substantially wraps the fertilizer core and the polymer layer is substantially in contact with the fertilizer core.

In an embodiment, heat is applied to the polymer layer to substantially wrap the fertilizer composition. In an embodiment, the polymer layer has a water permeability of 10 to 500 g/m2/day at 25 degrees Celsius and wherein the fertilizer composition is configured to be placed in a field at a predetermined distance from a row crop seed whereby the fertilizer composition delivers an effective amount of nitrogen during the reproductive growth stage of the row crop. In an embodiment, the fertilizer core comprises about 0.1 to 0.8 grams of nitrogen.

A method of producing an extended-release agricultural composition, the method includes extruding a first polymer layer on a plurality of agricultural beads such that the plurality of the beads are substantially encapsulated by the polymer layer, wherein the polymer layer has a water permeability of about 1 to about 2000 g/m2/day at 25 degrees Celsius and wherein the agricultural composition comprises about 0.1 to 0.8 grams of nitrogen, whereby the agricultural composition delivers an effective amount of nitrogen during the reproductive growth stage of the row crop. In an embodiment, the agricultural composition is between about 6 and 14 mm in diameter and comprises an aspect ratio of between about 1 and 3. In an embodiment, the extrusion further comprises a second polymer layer.

A method of increasing yield of a crop in a field, the method includes providing an agricultural composition during planting of the crop seed in the field, wherein the agricultural composition comprises a fertilizer composition, wherein the fertilizer composition releases about 70-90 cumulative % of nitrogen between about 30-90 days into soil after planting the crop seed; and a crop protection composition, wherein the crop protection composition is released into the soil such that about 70-90 cumulative % of one or more active ingredients in the crop protection composition is available to the crop during about 20-100 days after planting the crop seed; wherein the agricultural composition comprises a biodegradable polymer layer and thereby increasing the yield due to protection offered by the crop protection agents against late season pests and diseases.

In an embodiment, the crop is selected from the group consisting of maize, soybean, wheat, rice, sorghum, cotton, millet and barley.

In an embodiment, the fertilizer composition a nutrient selected from the group consisting of nitrogen, phosphorus, potassium and a combination thereof. In an embodiment, the nitrogen source includes urea, the phosphorus source includes for example, ammonium phosphate, superphosphate, and rock phosphate; and the potassium source includes potash.

In an embodiment, the agricultural composition is provided at planting of the crop seed or prior to planting the crop seed.

In an embodiment, the soil is classified as a soil type that has a lower water holding capacity.

In an embodiment, the crop protection composition is selected from the group consisting of an insecticide, a fungicide, a nematicide and a combination thereof.

In an embodiment, the crop protection composition is selected from the group consisting of an anthranilic diamide insecticide, a neonicotinoid insecticide and a combination thereof. In an embodiment, the neonicotinoid insecticide is released into the soil such that an effective amount of the insecticide is present in the soil when the target pest is present in the field during the later developmental stages of the crop. In an embodiment, the anthranilic diamide insecticide is released into the soil such that an effective amount of about 5-60 g/hectare is present in the soil after about 20-100 days from providing the agricultural composition in the field.

In an embodiment, the field is characterized by the presence of one or more late season pests that target corn or soybeans. In an embodiment, the late season pest is corn root worm.

In an embodiment, the crop protection composition is selected from the group consisting of, thiamethoxam, clothianidin, imidacloprid, thiodicarb, carbaryl, chlorantraniliprole, cyantraniliprole, methiocarb, thiram, azoxystrobin, paclobutrazol, acibenzolar-S-methyl, chlorothalonil, mandipropamid, thiabendazole, chlorothalonil, triadimenol, cyprodinil, penconazole, boscalid, bixafen, fluopyram, fenpropidin, fluxapyroxad, penflufen, fluoxastrobin, kresoxim-methyl, benthiavalicarb, benthiavalicarb-isopropyl, dimethomorph, flusulfamide, methyl thiophanate, triticonazole, flutriafol, thiram, carboxin, carbendazim and a combination thereof.

In an embodiment, the crop is maize and the yield increase in the field is about 5% to about 50% compared to a control field wherein a control fertilizer composition comprising a normal release profile of nitrogen is applied, wherein both the fertilizer composition and the control fertilizer composition comprise substantially the same total nitrogen content at planting. Suitable yield increase compared to an appropriate control includes for example, at least about 3%, 4%, 5%, 6%, 7%, 8%, 9%, 10%, 15%, 20% and 30%.

In an embodiment, the crop is maize and the crop seed is planted at a planting density of about 15,000 to about 70,000 plants per acre at a row spacing of about 15 inches to about 40 inches.

In an embodiment, the crop protection composition comprises an effective amount of a pesticide that results in a reduced seed germination or reduced seedling stand or reduced crop response if the effective amount of the pesticide is applied as a seed treatment to the crop seed.

In an embodiment, the crop protection composition comprises an effective amount of a pesticide that results in a reduced seed germination or reduced seedling stand if the effective amount of the pesticide is applied as an in furrow application to the soil.

A method of providing a plurality of extended release agricultural beads to a crop field comprising a plurality of crop seeds, the method includes providing the agricultural bead at a depth of about ⅓^{rd} inch, 0.5 inch, and 1 inch to about 10 inches into the crop field; at a distance of about 1 inch to about 15 inches from the crop seeds; and wherein the agricultural bead comprises a biodegradable polymer layer and a fertilizer composition such that a nitrogen release profile of about 70-90 cumulative % of nitrogen between about 50-120 days into soil after planting the crop seeds is achieved and wherein the number of the agricultural beads is not substantially greater than the number of crop seeds in the field. Suitable planting depths for the agricultural composition include for example 0.5, 1, 2, 3, 4, 5, 6, 7, 8, 9, 10, 11, and 12 inches from the surface soil. In an embodiment, agricultural compositions disclosed herein are broadcast applied either alone or in a blend with other surface applied components such as soil such that when the agricultural composition is in the field, they are partially covered by soil.

In an embodiment, the agricultural bead further comprises a crop protection composition, wherein the crop protection composition is released into the soil such that about 90 cumulative % of one or more active ingredients in the crop protection composition is available to the crop during about 50-150 days after planting the crop seed.

A method of fertilizing a crop, the method includes providing a plurality of extended release agricultural bead to a crop field comprising a plurality of crop seeds during planting, the method comprising providing the agricultural bead: at a depth of about 2 inches to about 10 inches into the crop field; at a distance of about 1 inch to about 15 inches from the crop seeds, wherein the agricultural bead comprises a biodegradable polymer layer and a fertilizer composition such that a nitrogen release profile of about 70-90 cumulative % of nitrogen between about 50-120 days into soil after planting the crop seeds is achieved and wherein the number of the agricultural beads is not substantially greater than the number of crop seeds in the field; and providing a normal release fertilizer composition at the time of planting or sufficiently prior to planting.

An agricultural composition comprising a blend of extended release fertilizer composition comprising a biodegradable polymer layer and a normal release fertilizer composition, wherein the extended release fertilizer composition releases nitrogen at a release rate of about 70-90 cumulative % of nitrogen between about 50-120 days into soil after planting, wherein the biodegradable polymer layer encapsulates the fertilizer composition that is configured to be planted in the soil sufficiently adjacent to a crop seed. In an embodiment, the blend comprises about one tenth to about two-thirds extended release fertilizer composition. Suitable blending ranges include for example, extended release: normal release fertilizer in the ratio of 1:10, 1:9, 1:8, 1:7, 1:6; 1:5, 1:4, 1:3, 1:2 and 1:1. Depending on the amount of fertilizer component present in each tablet or bead, the blending ratio can be modified for example from 1:20 to about 1:1. In an embodiment, the blend comprises about one third extended release fertilizer composition. In an embodiment, the biodegradable polymer layer is selected from the group consisting of polylactic acid, poly butylene adipate succinate, polyvinyl acetate, polyvinyl alcohol, polycaprolactone, alginate, xanthan gum and a combination thereof. In an embodiment, the composition is planted in furrow. In an embodiment, the composition is planted sub-surface.

In an embodiment, the polymer containing agricultural composition for example, PLA-coated urea tablet or PLA or PBSA extruded beads containing crop protection agents may include additional filler component such as starch or another biodegradable component to modify the release profiles or to reduce the manufacturing cost of the extended release compositions.

An agricultural composition comprising a fertilizer core comprising from about 0.01 to about 0.5 grams of phosphate or potash; and a polymer layer surrounding the fertilizer core; wherein the polymer layer has a water permeability of about 1 to about 2000 g/m2/day at 25 degrees Celsius and wherein the fertilizer composition is configured to be placed in a field at a predetermined distance from a row crop seed whereby the fertilizer composition delivers an effective amount of nitrogen during the reproductive growth stage of the row crop. In an embodiment, the fertilizer composition is between about 6 and 14 mm in diameter.

A method of increasing yield of a crop plant, the method includes providing an extended release agricultural composition to a field comprising a plurality of crop plants, wherein the crop plant expresses an agronomic trait and wherein the extended release composition comprises a polymer layer that has a water permeability of about 1 to about 2000 g/m2/day at 25 degrees Celsius; and wherein the extended release composition is between about 6 and 14 mm in diameter; growing the crop plant in a crop growing environment and thereby increasing the yield of the crop plant. In an embodiment, the agronomic trait is a nitrogen use efficiency trait. In an embodiment, the agronomic trait is an insect resistance trait. In an embodiment, the agronomic trait is expressed by a recombinant DNA construct. In an embodiment, the agronomic trait is a drought tolerance trait. In an embodiment, the agronomic trait is engineered through a genomic modification of the endogenous DNA. In an embodiment, the agronomic trait is a disease resistance trait. In an embodiment, the insect resistance trait is due to the expression of a component selected from the group consisting of Bt gene, short interfering RNA molecule targeted to a pest, heterologous non-Bt insecticidal protein, and a combination thereof. In an embodiment, the crop plant is selected from the group consisting of maize, soybean, rice, wheat, sorghum, cotton, canola, alfalfa and sugarcane.

An agricultural system includes a plurality of extended release agricultural compositions comprising a polymer layer that has a water permeability of 10 to 500 g/m2/day at 25 degrees Celsius; wherein each of the extended release composition is between about 6 and 14 mm in diameter; a planting equipment configured to place the extended release agricultural compositions at a sufficient depth in a soil surface of a crop field; and a plurality of crop seeds, wherein the crop seeds are planted at a sufficient distance from the placement of the agricultural compositions and wherein the crop seeds are planted immediately before or after the placement of the agricultural compositions.

In an embodiment, the extended release composition comprises a fertilizer composition. In an embodiment, the extended release composition comprises a crop protection active ingredient. In an embodiment, the crop seeds are maize.

In an embodiment, the planting equipment is a seed planter. In an embodiment, the planting equipment plants both the agricultural compositions and the crop seeds in a single pass across the field. In an embodiment, the planting equipment alternates between placing the agricultural composition and planting the crop seeds. In an embodiment, the planting equipment is a pneumatic disc planter. In an embodiment, the planting equipment delivers the agricultural composition that comprises a fertilizer component and a crop protection active ingredient. In an embodiment, the planting equipment delivers the agricultural composition that comprises a fertilizer component and a crop protection active ingredient simultaneously.

A method of increasing yield of a crop plant, the method includes broadcast spreading an extended release agricultural composition to a field comprising a plurality of crop plants, wherein the extended release composition comprises a polymer layer that has a water permeability of 10 to 500 g/m2/day at 25 degrees Celsius; and wherein the extended release composition is between about 6 and 14 mm in diameter; and growing the crop plant in a crop growing environment and thereby increasing the yield of the crop plant. In an embodiment, the agricultural composition comprises about 0.1 to 0.8 grams of nitrogen and the polymer layer is about 8-250 microns thick.

### BRIEF DESCRIPTION OF THE DRAWINGS

FIG. 1 shows a variety of configurations of polymer containing extended release agricultural compositions described herein. These include a nutrient core having a polymer shell, crop protection active ingredient mixed within a core composition having dispersed polymer, crop protection active in liquid formulation spray coated onto a polymer containing core, and crop protection active ingredient mixed in with a nutrient core surrounded by a polymer shell. In the illustration shown, the core is formed by either by extrusion or by compaction and the shell is formed by either spray coating or film wrapping.

FIG. 2 is a schematic illustration of a batch coating of PLA polymer on urea tablets. Urea tablets are made from urea granulation of prills, followed by sizing step that includes sieving and passing through a coarse mesh to select appropriate size granules and urea tablets of appropriate shape and size are formed by compaction. The polymer coating (PLA as in illustrative example) process starts with polymer dissolution in a heated process, followed by dye mixing if a particular color is desired and batch film coating of the urea tablets in a rotary compartment. Graphite may be added as a lubricant during the coating process of urea tablets.

FIG. 3 shows the cumulative release of urea into water at 22° C. from PLA-coated urea prills (3-5 mm) which are coated at three different ratios (5.1, 7.4 and 9.7% based on the mass ratio of PLA to urea).

FIG. 4 shows the cumulative release of PLA-coated urea (1600 mg) tablet into water at 22° C. at five different ratios (2.6, 3.8, 5.0, 7.5 and 10% based on the mass ratio of PLA to urea).

FIG. 5 shows the cumulative release of tablets that are 13 mm in diameter and of standard shape and contain 1600 mg urea per tablet urea into water at 35° C. from PLA-coated urea tablets which are coated at three different ratios (2.6, 3.8, and 5.0% based on the mass ratio of PLA to urea).

FIG. 6 shows cumulative release of urea into water at 22° C. from PLA-coated urea tablets. The samples are prepared by a spraying coating process using 10 wt % PLA solution in MEK and tablets that are 11.1 mm in diameter and of different shapes (standard, deep, extra deep and modified ball).

FIG. 7 shows cumulative release of 9.5 mm urea tablet into water at 22° C. from PLA-coated urea tablets which are coated at three different ratios (4.1, 5.6 and 7.1% based on the mass ratio of PLA to urea).

FIG. 8 shows the cumulative release of urea into water at 22° C. from 9.5 mm PLA-coated urea tablets which are coated at four different ratios (2.8, 3.75, 5.5 and 6.35% based on the mass ratio of PLA to urea).

FIG. 9 shows the cumulative release of urea into water at 35° C. from PLA-coated urea 9.5 mm tablets (535 mg urea) which are coated at four different ratios (2.8, 3.75, 5.5 and 6.35% based on the mass ratio of PLA to urea).

FIG. 10 shows the cumulative release of urea into water at 22° C. from PLA-coated urea 9.5 mm tablets (535 mg urea/tablet) which are coated at three different ratios (2.2, 4.1 and 6.5% based on the mass ratio of PLA to urea).

FIG. 11 shows the cumulative release of urea into water at 22° C. from film-wrapped urea tablets of 9.5 mm diameter and 535 mg of urea.

FIG. 12 shows cumulative release of urea into water at 22° C. from film-wrapped urea tablets of extra deep shape and contain 535 mg urea per tablet.

FIG. 13 shows cumulative release of total nitrogen into Fruitland soil at 25° C. from PLA-coated urea tablets (535 mg urea per tablet) which are coated at three different ratios (2.6, 3.8 and 5.0% based on the mass ratio of PLA to urea).

FIG. 14 shows cumulative release of total nitrogen into Sciota soil at 25° C. from PLA-coated urea tablets (535 mg urea per tablet) which are coated at three different ratios (2.6, 3.8 and 5.0% based on the mass ratio of PLA to urea).

FIG. 15 shows cumulative release of total nitrogen into Sciota soil at 25° C. from PLA-coated urea tablets (535 mg urea per tablet) which are coated at three different ratios (4.1, 5.6 and 7.1% based on the mass ratio of PLA to urea).

FIG. 16 shows cumulative release of total nitrogen into Sciota soil at 25° C. from PLA-coated urea tablets (535 mg urea per tablet) which are coated at four different ratios (2.8, 3.75, 5.5 and 6.35% based on the mass ratio of PLA to urea).

FIG. 17 shows cumulative release of total nitrogen into Fruitland soil at 25° C. from PLA shrink-wrapped ammonium sulfate tablets (1900 mg ammonium sulfate per tablet).

FIG. 18 shows Thiamethoxam concentration in maize hybrid leaves from a variety of sources. Positive control is the seed treatment application of Thiamethoxam.

FIG. 19 shows mean Clothianidin concentration in maize leaves from a variety of sources. Pos. Ctrl indicates the Clothianidin 1250 applied as a seed treatment.

FIG. 20 shows the % Al release for Flutriafol in soil after 1-5 weeks after planting for prototypes F-E and F-F.

FIG. 21 shows soil release curves for thiamethoxam containing bead compositions. The bead prototype designation corresponds to those shown in Example 9.

FIG. 22 shows soil release for the fungicide active ingredient azoxystrobin present in PLA coated tablet, uncoated struvite (magnesium ammonium phosphate) tablet and PBSA extruded bead containing corn starch and calcium phosphate.

FIG. 23 shows soil release profile for the insecticide active ingredient clothianidin present in PLA coated tablet, PLA coated urea tablet and PBSA extruded bead containing corn starch and calcium phosphate. The Urea/clothianidin PBSA 4 mil tablet corresponds to a film-wrapped tablet designated prototype I-D.

FIG. 24 shows the mean concentrations of Azoxystrobin for negative controls grown in the corn controlled environments tests described in Example 10. The bars (in most cases smaller that the plotted symbol) indicate the 95% confidence interval for the mean values. Individual standard deviations were used to calculate the confidence intervals. DAD—day after delivery of the bead. No crop protection agent was used in the control plots.

FIG. 25 shows the mean thiamethoxam concentration in leaf samples collected during the corn controlled environments tests described in Example 10. The bars indicate the 95% confidence interval for the mean values. Individual standard deviations were used to calculate the confidence intervals. DAD—day after delivery of the bead.

FIG. 26 shows the mean clothianidin concentration in leaf samples collected during the corn controlled environments tests described in Example 10. The bars indicate the 95% confidence interval for the mean values. Individual standard deviations were used to calculate the confidence intervals. DAD—day after delivery of the bead.

FIG. 27 shows the mean azoxystrobin concentration in leaf samples collected during the corn controlled environments tests described in Example 10. The bars indicate the 95% confidence interval for the mean values. Individual standard deviations were used to calculate the confidence intervals. DAD—day after delivery of the bead

FIG. 28 shows the mean leaf E2Y (chlorantraniliprole) concentration in the corn growth chamber trial. The bars indicate the 95% confidence interval for the mean values. Individual standard deviations were used to calculate the confidence intervals. DAD—day after delivery of the bead.

FIG. 29 shows the mean leaf HGW (cyantraniliprole) concentration in corn growth chamber trial. The bars indicate the 95% confidence interval for the mean values. Individual standard deviations were used to calculate the confidence intervals. DAD—day after delivery of the bead.

FIG. 30 shows the mean leaf E2Y (chlorantraniliprole) concentration in soybean growth chamber trial. The bars indicate the 95% confidence interval for the mean values. Individual standard deviations were used to calculate the intervals. DAD—day after delivery of the bead.

FIG. 31 shows the mean leaf HGW (cyantraniliprole) concentration in soybean growth chamber trial. The bars indicate the 95% confidence interval for the mean values. Individual standard deviations were used to calculate the intervals. DAD—day after delivery of the bead.

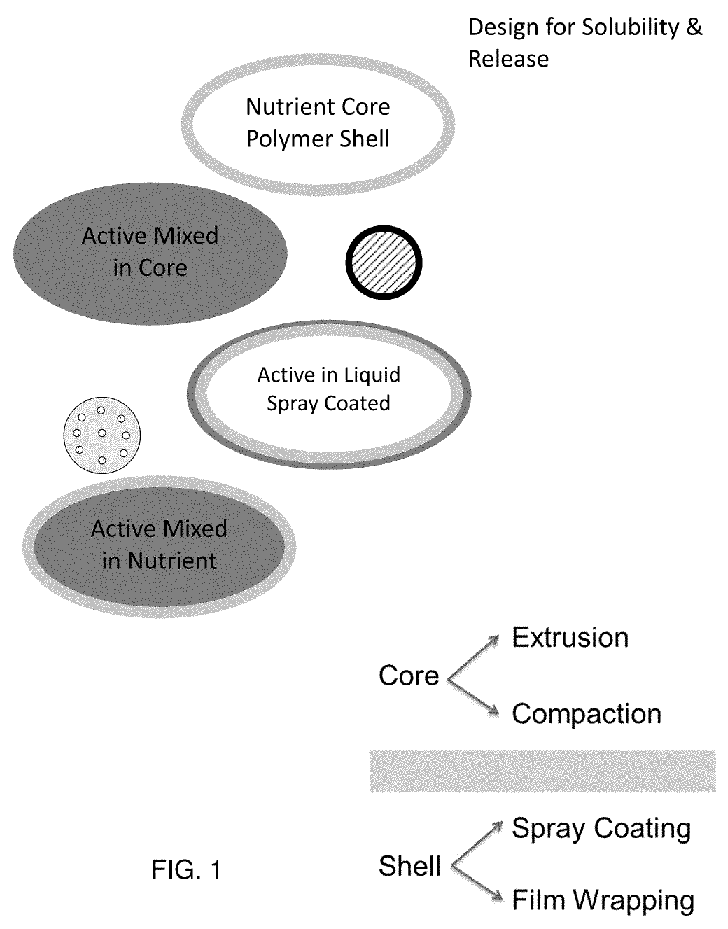

### DETAILED DESCRIPTION

The disclosures of the priority application U.S. Ser. No. 62/311,911 filed Mar. 23, 2016, all cited patent and non-patent literature are incorporated herein by reference in their entirety.

The use of numerical values in the various ranges specified in this application, unless expressly indicated otherwise, are stated as approximations as though the minimum and maximum values within the stated ranges were both preceded by the word “about”. In this manner, slight variations above and below the stated ranges can be used to achieve substantially the same results as values within the ranges. Also, the disclosure of these ranges is intended as a continuous range including each and every value between the minimum and maximum values.

Substantially free generally refers to absence of one or more components such that the detectable amount of such components are below a certain level where such low level presence does not alter the desirable characteristics of a compositions. For example, substantially free can mean the presence of a component less than 0.01%, 0.1%, 1%, 2%, 3%, 4%, 5%, or up to 10% of the total composition by weight. Substantially free can also include that a component is below the detectable limit threshold. For example, the term “substantially free of polyurethane” means that polyurethane is present only in trace quantity or at a low level that does not alter the desirable characteristics of a composition, such as, for example PLA.

A fertilizer composition includes a fertilizer core comprising from about 0.1 to 0.8 grams of nitrogen; and a polymer layer surrounding the fertilizer core; wherein the polymer layer has a water permeability of about 1 to about 2000 g/m2/day at 25 degrees Celsius and wherein the fertilizer composition is configured to be placed in a field at a predetermined distance from a row crop seed whereby the fertilizer composition delivers an effective amount of nitrogen during the reproductive growth stage of the row crop. Other suitable ranges of water permeability for the polymer layer include for example, about 10 to about 500; 100-200, 50-500, 100-500; 200-500; 300-600; 500-1000; 50-100; 100-1000 g/m2/day at 25 degrees Celsius.

An agricultural composition includes a fertilizer core; and a layer of a polymer surrounding the fertilizer core; wherein the agricultural composition has a water permeability of about 1 to about 2000 g/m2/day at 25 degrees Celsius; and wherein the fertilizer composition is between about 6 and 14 mm in diameter. Other suitable diameter ranges for the fertilizer composition include for example, about 8-12 mm; 7-10 mm; 8-14 mm; 7-14 mm; 6-10 mm; 9-13 mm; 5-15 mm and 10-15 mm.

In an embodiment, the fertilizer composition has an aspect ratio of between about 1 and 3. In an embodiment, the fertilizer composition is in the form of a sphere. In an embodiment, the fertilizer composition is in a non-spherical form. In an embodiment, the fertilizer composition is in the form of a cylinder. In an embodiment, the cylinder comprises either flat or rounded ends. In an embodiment, the fertilizer composition is in the form of a briquette. In an embodiment, the fertilizer composition is in the form of a mono-dispersed sphere.

In an embodiment, the fertilizer composition is configured to flow through a seed planter. In an embodiment, the seed planter moves at a speed about 2-20 or 5-15 mph and the agricultural composition is planted at a density of about 10,000 to about 300,000/acre, wherein each of the agricultural composition comprises about 100, 200, 300, 400, 500, 600, 700, 800, 900, 1000, 1100, and 1200 mg of nitrogen. Suitable ranges of nitrogen, for example in the form of urea, ammonia, or NH4+include for example, up to 200, 300, 400, 500, 600, 700, 800, 900, 1000 and 1500 mg per bead or tablet disclosed herein.

In an embodiment, the polymer layer is a biodegradable aliphatic polyester. In an embodiment, the polyester is polylactic acid comprising a weight averaged molecular weight of about 20 kDa to about 150 kDa. In an embodiment, the polymer layer is about 0.3 mil to about 10.0 mil thick. In an embodiment, other thicknesses include for example, 0.2-5; 0.5-2.0; 1.0-5.0; 0.4-4; 0.5; 0.6; 0.7; 0.8; 0.9; 1.0; 1.5; 2.0; 2.5; 3.0; 3.5; 4.0; 4.5; 5; 5.5; 6.0; 6.5; 7.0; 7.5; 8.0; 8.5; 9.0; 9.5; and 10.0 mil. In an embodiment, the polymer layer constitutes about 0.5% or 2% to no more than about 10% of the total weight (or amount) of the fertilizer composition. Suitable weight % include for example, 0.2, 0.4. 0.5, 0.6, 0.7, 0.8, 1.0, 1.5, 2, 2.5, 3, 3.5, 4, 4.5, 5, 5.5, 6, 6.5, 7, 7.5, 8, 8.5, 9, 9.5 and 10.

In an embodiment, the agricultural composition is in a shape as designated as ‘round convex’ tablets, made using tooling for “standard cup depth” or “extra deep cup depth,” as defined in table 10 of the Tableting Specification Manual, 7th edition, page 71, American Pharmacists Association, Washington DC, 2006 (TSM-7). Table 10 of the Tableting Specification Manual describes punch tip diameters ranging from about 3.175 mm for a standard cup depth of 0.432 mm or an extra-deep cup depth of 0.762 mm to about 25.4 mm for a standard cup depth of 1.854 mm or an extra-deep cup depth of 4.851 mm. Based on the description and guidance provided herein, one of ordinary skill in the art can choose an appropriate size and shape for the agricultural compositions described herein.

In an embodiment, the fertilizer composition has a release profile of about 15-25% cumulative N release in a crop growing field by about 40 days after planting. In an embodiment, the cumulative N release is about 60-90% in a maize growing field by about 60-90 days after planting. In an embodiment, suitable cumulative N release includes about 40-70%; 50-80%; 40-90%; 50-90%; 70-90%; 80-90%; 60-80%; 60-95% and 50-100% within about 20-150 days of planting. Other suitable cumulative % N release includes about 30, 35, 40, 45, 50, 55, 60, 65, 70, 75, 80, 85, 90, 95, and 100.

Depending on the crop (e.g., annual or perennial) the % nitrogen released and the timing of such release can be determined based on the disclosure herein and the various release profiles of the compositions disclosed. Suitable timing ranges include for example, of about 20, 30, 40, 50, 60, 70, 80, 90, 100, 110, 120, 130, 140, 150, 160, 170, 180, 190, and 200 days for annual crops and longer duration for perennial crops in the range of up to about 30, 90, 120, 150, 180, 210, 240, 270, and 300 days.

In an embodiment, the fertilizer composition has a hardness parameter between about 50N to about 150N. In an embodiment, the hardness parameter is about 100N. Suitable hardness parameter includes for example up to 200N, 250N, 300N, 350N, 400N and 500N; 100-300N, 50-500N, 200-300N, 250-500N, and any range within 50-500N.

A method of producing an extended-release fertilizer composition, the method includes providing a fertilizer core having a size aspect ratio of between about 1 and 3; placing the fertilizer core in a polymer layer film, wherein the polymer layer comprises a thickness of about 0.4 mil to about 10.0 mil; and applying force such that the polymer layer substantially wraps the fertilizer core and the polymer layer is substantially in contact with the fertilizer core.

In an embodiment, the heat is applied to the polymer layer to substantially wrap the fertilizer composition. In an embodiment, the polymer layer has a water permeability of 10 to 500 g/m2/day at 25 degrees Celsius and wherein the fertilizer composition is configured to be placed in a field at a predetermined distance from a row crop seed whereby the fertilizer composition delivers an effective amount of nitrogen during the reproductive growth stage of the row crop. In an embodiment, the fertilizer core comprises about 0.1 to 0.8 grams of nitrogen.

A method of producing an extended-release agricultural composition, the method includes extruding a first polymer layer on a plurality of agricultural beads such that the plurality of the beads are substantially encapsulated by the polymer layer, wherein the wherein the polymer layer has a water permeability of about 1 to about 2000 g/m2/day at 25 degrees Celsius and wherein the agricultural composition comprises about 0.1 to 0.8 grams of nitrogen, whereby the agricultural composition delivers an effective amount of nitrogen during the reproductive growth stage of the row crop. In an embodiment, the agricultural composition is between about 6 and 14 mm in diameter and comprises an aspect ratio of between about 1 and 3. In an embodiment, the extrusion further comprises a second polymer layer.

A method of increasing yield of a crop in a field, the method includes providing an agricultural composition during planting of the crop seed in the field, wherein the agricultural composition comprises a fertilizer composition, wherein the fertilizer composition releases about 70-90 cumulative % of nitrogen between about 30-90 days into soil after planting the crop seed; and a crop protection composition, wherein the crop protection composition is released into the soil such that about 70-90 cumulative % of one or more active ingredients in the crop protection composition is available to the crop during about 20-100 days after planting the crop seed; wherein the agricultural composition comprises a biodegradable polymer layer and thereby increasing the yield. In an embodiment, suitable cumulative crop protection active ingredient release includes about 40-70%; 50-80%; 40-90%; 50-90%; 70-90%; 80-90%; 60-80%; 60-95% and 50-100% of the total active ingredient present in the composition within about 20-150 days of planting. Other suitable cumulative % crop protection active ingredient release includes 30, 35, 40, 45, 50, 55, 60, 65, 70, 75, 80, 85, 90, 95, and 100. The mid to late season pests for a particular crop depends on the nature of the crop, the location and the appearance of the pest pressure. For example, mid/late season pests may appear during the reproductive stage of a plant.

In an embodiment, the crop is selected from the group consisting of maize, soybean, wheat, rice, sorghum, millet and barley.

In an embodiment, the fertilizer composition a nutrient selected from the group consisting of nitrogen, phosphorus, potassium and a combination thereof.

In an embodiment, the agricultural composition is provided at planting of the crop seed or prior to planting the crop seed.

In an embodiment, the soil is classified as a soil type that has a lower water holding capacity.

In an embodiment, the crop protection composition is selected from the group consisting of an insecticide, a fungicide, a nematicide and a combination thereof.

In an embodiment, the crop protection composition is selected from the group consisting of an anthranilic diamide insecticide, a neonicotinoid insecticide and a combination thereof. In an embodiment, the neonicotinoid insecticide is released into the soil such that an effective amount of the insecticide is present in the soil when the target pest is present in the field during the later developmental stages of the crop. In an embodiment, the anthranilic diamide insecticide is released into the soil such that an effective amount of about 5-60 g/hectare is present in the soil after about 20-100 days from providing the agricultural composition in the field.

In an embodiment, the field is characterized by the presence of one or more late season pests that target corn or soybeans. In an embodiment, the late season pest is corn root worm.

In an embodiment, the crop protection composition is selected from the group consisting of, thiamethoxam, clothianidin, imidacloprid, thiodicarb, carbaryl, chlorantraniliprole, cyantraniliprole, methiocarb, thiram, azoxystrobin, paclobutrazol, acibenzolar-S-methyl, chlorothalonil, mandipropamid, thiabendazole, chlorothalonil, triadimenol, cyprodinil, penconazole, boscalid, bixafen, fluopyram, fenpropidin, fluxapyroxad, penflufen, fluoxastrobin, kresoxim-methyl, benthiavalicarb, benthiavalicarb-isopropyl, dimethomorph, flusulfamide, methyl thiophanate, triticonazole, flutriafol, thiram, carboxin, carbendazim and a combination thereof.

In an embodiment, the crop is maize and the yield increase in the field is about 10% to about 50% compared to a control field wherein a control fertilizer composition comprising a normal release profile of nitrogen is applied, wherein both the fertilizer composition and the control fertilizer composition comprise substantially the same total nitrogen content at planting.

In an embodiment, the crop is maize and the crop seed is planted at a planting density of about 15,000 to about 70,000 plants per acre at a row spacing of about 15 inches to about 40 inches. Suitable planting densities include for example, about 10,000; 15,000; 20,000; 25,000; 30,000; 35,000; 40,000; 45,000; 50,000; 55,000; 60,000; 65,000; 70,000 and 75,000.

In an embodiment, the crop protection composition comprises an effective amount of a pesticide that results in a reduced seed germination or reduced seedling stand or reduced crop response if the effective amount of the pesticide is applied as a seed treatment to the crop seed.

In an embodiment, the crop protection composition comprises an effective amount of a pesticide that results in a reduced seed germination or reduced seedling stand if the effective amount of the pesticide is applied as an in furrow application to the soil.

A method of providing a plurality of extended release agricultural beads to a crop field comprising a plurality of crop seeds, the method includes providing the agricultural bead at a depth of about 1 inch to about 10 inches into the crop field; at a distance of about 1 inch to about 15 inches from the crop seeds; and wherein the agricultural bead comprises a biodegradable polymer layer and a fertilizer composition such that a nitrogen release profile of about 70-90 cumulative % of nitrogen between about 50-120 days into soil after planting the crop seeds is achieved and wherein the number of the agricultural beads is not substantially greater than the number of crop seeds in the field. In an embodiment, suitable planting depths for the beads include for example, 0.5, 1, 2, 3, 4, 5, 6, 7, 8, 9, 10, 11, and 12 inches from the top of soil surface and about 0.5, 1, 2, 3, 4, 5, 6, 7, 8, 9, 10, 11, and 12 inches distal from where the crop seed is placed.

In an embodiment, the agricultural bead further comprises a crop protection composition, wherein the crop protection composition is released into the soil such that about 90 cumulative % of one or more active ingredients in the crop protection composition is available to the crop during about 50-150 days after planting the crop seed.

A method of fertilizing a crop, the method includes providing a plurality of extended release agricultural bead to a crop field comprising a plurality of crop seeds during planting, the method comprising providing the agricultural bead: at a depth of about 2 inches to about 10 inches into the crop field; at a distance of about 1 inch to about 15 inches from the crop seeds, wherein the agricultural bead comprises a biodegradable polymer layer and a fertilizer composition such that a nitrogen release profile of about 70-90 cumulative % of nitrogen between about 50-120 days into soil after planting the crop seeds is achieved and wherein the number of the agricultural beads is not substantially greater than the number of crop seeds in the field; and providing a normal release fertilizer composition at the time of planting or sufficiently prior to planting.

An agricultural composition comprising a blend of extended release fertilizer composition comprising a biodegradable polymer layer and a normal release fertilizer composition, wherein the extended release fertilizer composition releases nitrogen at a release rate of about 70-90 cumulative % of nitrogen between about 50-120 days into soil after planting, wherein the biodegradable polymer layer encapsulates the fertilizer composition that is configured to be planted in the soil sufficiently adjacent to a crop seed. In an embodiment, the blend comprises about one fourth to about two-thirds extended release fertilizer composition. In an embodiment, the blend comprises about one third extended release fertilizer composition. In an embodiment, the biodegradable polymer layer is selected from the group consisting of polylactic acid, poly butylene adipate succinate, polyvinyl acetate, polyvinyl alcohol, polycaprolactone, alginate, xanthan gum and a combination thereof. In an embodiment, the composition is planted in furrow. In an embodiment, the composition is planted sub-surface.

A fertilizer composition comprising a fertilizer core comprising from about 0.01 to about 0.5 grams of phosphate or potash; and a polymer layer surrounding the fertilizer core; wherein the polymer layer has a water permeability of about 1 to about 2000 g/m2/day at 25 degrees Celsius and wherein the fertilizer composition is configured to be placed in a field at a predetermined distance from a row crop seed whereby the fertilizer composition delivers an effective amount of nitrogen during the reproductive growth stage of the row crop. In an embodiment, the fertilizer composition is between about 6 and 14 mm in diameter.

A method of increasing yield of a crop plant, the method includes providing an extended release agricultural composition to a field comprising a plurality of crop plants, wherein the crop plant expresses an agronomic trait and wherein the extended release composition comprises a polymer layer that has a water permeability of about 1 to about 2000 g/m2/day at 25 degrees Celsius; and wherein the extended release composition is between about 6 and 14 mm in diameter; growing the crop plant in a crop growing environment and thereby increasing the yield of the crop plant. In an embodiment, the agronomic trait is a nitrogen use efficiency trait. In an embodiment, the agronomic trait is an insect resistance trait. In an embodiment, the agronomic trait is expressed by a recombinant DNA construct. In an embodiment, the agronomic trait is a drought tolerance trait. In an embodiment, the agronomic trait is engineered through a genomic modification of the endogenous DNA. In an embodiment, the agronomic trait is a disease resistance trait. In an embodiment, the insect resistance trait is due to expression of a component selected from the group consisting of Bt gene, short interfering RNA molecule targeted to a pest, heterologous non-Bt insecticidal protein, and a combination thereof. In an embodiment, the crop plant is selected from the group consisting of maize, soybean, rice, wheat, sorghum, cotton, canola, alfalfa and sugarcane.

An agricultural system includes a plurality of extended release agricultural compositions comprising a polymer layer that has a water permeability of 10 to 500 g/m2/day at 25 degrees Celsius; wherein each of the extended release composition is between about 6 and 14 mm in diameter; a planting equipment configured to place the extended release agricultural compositions at a sufficient depth in a soil surface of a crop field; and a plurality of crop seeds, wherein the crop seeds are planted at a sufficient distance from the placement of the agricultural compositions and wherein the crop seeds are planted immediately before or after the placement of the agricultural compositions.

In an embodiment, the extended release composition comprises a fertilizer composition. In an embodiment, the extended release composition comprises a crop protection active ingredient. In an embodiment, the crop seeds are maize.

In an embodiment, the planting equipment is a seed planter. In an embodiment, the planting equipment plants both the agricultural compositions and the crop seeds in a single pass across the field. In an embodiment, the planting equipment alternates between placing the agricultural composition and planting the crop seeds. In an embodiment, the planting equipment is a pneumatic disc planter. In an embodiment, the planting equipment delivers the agricultural composition that comprises a fertilizer component and a crop protection active ingredient. In an embodiment, the planting equipment delivers the agricultural composition that comprises a fertilizer component and a crop protection active ingredient simultaneously.

A method of increasing yield of a crop plant, the method includes broadcast spreading an extended release agricultural composition to a field comprising a plurality of crop plants, wherein the extended release composition comprises a polymer layer that has a water permeability of 10 to 500 g/m2/day at 25 degrees Celsius; and wherein the extended release composition is between about 2 and 14 mm in diameter; and growing the crop plant in a crop growing environment and thereby increasing the yield of the crop plant. In an embodiment, the agricultural composition comprises about 0.1 to 0.8 grams of nitrogen and the polymer layer is about 10-250 microns thick

As used herein:

The term “pesticide” refers to any chemical classified as a pesticide or active ingredient (a.i.) by an appropriate regulatory authority; for example in the United States by the Environmental Protection Agency (EPA). Generally, a pesticide is a chemical which, when applied in a pesticidally sufficient amount to a susceptible plant, pest and/or microorganism and/or to the locus thereof, kills, inhibits or alters the growth of the plant, pest and/or microorganism.

As used herein, the term “propagule” means a seed. The term “regenerable plant part” means a part of a plant other than a seed from which a whole plant may be grown or regenerated when the plant part is placed in horticultural or agricultural growing media such as, for example, moistened soil, peat moss, sand, vermiculite, perlite, rock wool, fiberglass, coconut husk fiber, tree fern fiber, or a completely liquid medium such as water. The term “geotropic propagule” means a seed or a regenerable plant part obtained from the portion of a plant ordinarily disposed below the surface of the growing medium. Geotropic regenerable plant parts include viable divisions of rhizomes, tubers, bulbs and corms which retain meristematic tissue, such as an eye. Regenerable plant parts such as cut or separated stems and leaves derived from the foliage of a plant are not geotropic and thus are not considered geotropic propagules. As referred to in the present disclosure and claims, unless otherwise indicated, the term “seed” specifically refers to an unsprouted seed or seeds. The term “foliage” refers to parts of a plant exposed above ground. Therefore foliage includes leaves, stems, branches, flowers, fruits and/or buds. The phrase “resultant plant” refers to a plant that has been grown or regenerated from a propagule that has been placed in growing media.

The term “rhizosphere” refers to the area of soil that is directly influenced by plant roots and microorganisms in the soil surrounding the roots. The area of soil surrounding the roots is generally considered to be about 1 millimeter (mm) wide but has no distinct edge.

As used herein the term “encapsulation” or “encapsulated” generally refers to a composition that includes a distributed active component within or surrounded by a polymer matrix.

The term “extended release” or “sustained release” or “delayed release” or “controlled release”, used interchangeably herein, generally refers to a formulated composition, such as for example, a tablet, a capsule, or a bead, whose active ingredients such as nutrients, urea, crop protection agents are discharged more slowly into the surrounding zone due to the presence of one or more polymer components which restrict diffusion compared to compositions that do not contain such polymer components.

The term “biodegradable” in the context of a polymer generally refers to polymers that are break down after its intended purpose (such as, release of nutrients and/or crop protection agents) to result in natural byproducts such as gases (CO₂, N₂), water, biomass, and inorganic salts, in the intended environmental surrounding, such as, soil. In certain aspects, it may be desirable to use a biodegradable polymer such that it breaks down in the soil during a growing season or within 2-4 growing seasons. Further, a generally accepted protocols for determining biodegradability of polymer compositions such as for example, ASTM standard D6868-11 or historical version D6868-03 (Standard Specification for Labeling of End Items that Incorporate Plastics and Polymers as Coatings or Additives).

As used herein the phrase “biologically effective amount” refers to that amount of a substance required to produce a desired effect on a plant, on an insect, or a plant pest. Effective amounts of the substance depend on several factors, including the treatment method, plant species, pest species, propagating material type and environmental conditions. For example, a biologically effective amount of an insecticide would be the amount of the insecticide that protects a plant from damage. This does not mean that the protected plant suffers no damage from the pest, but that the damage is at such a level as to allow the plant to provide an acceptable yield of a crop.

The term “crop protection agent” or “crop protection active ingredient” generally refers to one or more components that target pests and/or weeds. Crop protect agents include for example, insecticide, fungicide, nematicide, herbicide, safener and can be chemical or biological (e.g., microbes, polypeptides, nucleic acids) or a combination thereof.

Micronutrients include for example, boron, zinc, manganese, iron, copper, molybdenum, chloride and others that can be included as part of the extended delivery agricultural compositions disclosed herein.

The term “Log Kow” is a relative indicator of the tendency of an organic compound to adsorb to soil. For various agriculturally important pesticides, these values are generally provided by the manufacturer or are known in the art.

“Water solubility” is the solubility of a compound in water, typically measured at 25° C. As with the Log Kow value, these values for various pesticides are typically provided by the manufacturer and are known in the art.

The transitional phrase “consisting essentially of” as used in the context of a particular component or a plurality of components, a step or steps enumerated in a method, generally means those specified components or steps and those that do not materially affect the basic and novel characteristic(s) of the claimed components or steps of a method. For example, an agricultural composition comprising a polymer layer consisting essentially of polylactic acid (PLA) may include other components including polymer components that, when present at such levels that do not materially alter the basic characteristics of PLA for which PLA is being used.

Polylactic acid (PLA) can be amorphous or semi-crystalline form or in the form of poly-L-lactide. For example, a suitable grade of PLA used in a film wrapping or extrusion have a higher melting point for example around 150-170° C., tensile strength of 15 kpsi (MD) or 21 kpsi (TD). Suitable PLA polymer includes commercially available polymer made of a grade of semi-crystalline polylactic acid containing ˜2% of D-isomer units with a number averaged molecular weight of 72 KDa; of a grade of amorphous polylactic acid containing 8-10% of D-isomer units with a number averaged molecular weight of 48 KDa; and of a grade of amorphous polylactic acid containing 8-10% of D-isomer units with a number averaged molecular weight of 118 KDa.

The disclosed method comprises or consists essentially of the steps of:
A) providing an agricultural composition; and
B) placing the agricultural composition and a propagule in a growing media such as soil, wherein the agricultural composition and the propagule are placed distal to each other; and
   wherein the agricultural composition comprises:
i) a bead comprising a nutrient material and a pesticide;
wherein the pesticide in the bead has a log Kow in the range of from 1.2 to 3.0 and a water solubility at 25° C. in the range of from 0.5 to 150 milligrams/liter (mg/L). The agricultural composition can be placed distal to the propagule. The term “co-located” means that the agricultural composition and the propagule are placed into the growing media at any time within a growing season. In some embodiments, the propagule and the agricultural composition can be co-located at the time of planting, within one week of planting, within one month of planting, at the time of flowering or prior to or during pest pressure. Distal means that the distance between the propagule and the agricultural composition is in the range of from 0.1 centimeter (cm) to 100 centimeters. In certain embodiments, the distance between the propagule and the agricultural composition is in the range of from 0.5 cm to 50 cm. In still further embodiments, the distance between the propagule and the agricultural composition is in the range of from 1 cm to 25 cm. In the case of co-located beads, more than one bead may be co-located with each propagule. The distance between the beads and the propagule can be the average distance between each bead and the propagule. In some embodiments, the agricultural composition can be placed in the growing medium as a cluster of beads co-located with a propagule. The term “cluster of beads” means that multiple beads are placed together so that the average distance between each of the beads of the cluster is less than the distance between the center of mass of the cluster and the propagule. In other embodiments, the agricultural composition can be banded or placed in a row that runs approximately parallel to a row of propagules. In some embodiments, for example, in those cases utilizing mechanized agricultural processes, the planting device for placing propagules in growing media can be equipped to co-locate the agricultural composition as one or more beads at a point that is distal to the propagule either just before the propagule is delivered to the growing media or just after.

The nitrogen source can be, for example, urea, oxamide, melamine, dicyanodiamide, urea formaldehyde ammonium nitrate, ammonium magnesium nitrate, potassium nitrate or a combination thereof. The phosphorous source can be, for example, ammonium magnesium phosphate, ammonium metaphosphate, bone meal, brucite, calcined phosphate, calcium metaphosphate, calcium phosphate, calcium polyphosphate, diamido phosphate, calcium magnesium phosphate, phosphate rock, potassium phosphate, magnesium phosphate, monocalcium diammonium pyrophosphate, oxamidine phosphate, phosphate urea, potassium polyphosphate or a combination thereof.

The granular fertilizer core used in the present invention may be any conventional granular fertilizer, which contains fertilizer ingredients such as nitrogen, phosphorous, potassium, silicon, magnesium, calcium, manganese, boron, iron and so on, for supplying nutrients to cultivating crops. Typical examples thereof include nitrogen fertilizer such as urea, ammonium nitrate, ammonium magnesium nitrate, ammonium chloride, ammonium sulfate, ammonium phosphate, sodium nitrate, calcium nitrate, potassium nitrate, lime nitrogen, urea-form (UF), crotonylidene diurea (CDU), isobutylidene diurea (IBDU), guanylurea (GU); phosphate fertilizer such as calcium superphosphate, conc. superphosphate, fused phosphate, humic acid phosphorus fertilizer, calcined phosphate, calcined conc. phosphate, magnesium superphosphate, ammonium polyphosphate, potassium metaphosphate, calcium metaphosphate, magnesium phosphate, ammonium sulfate phosphate, ammonium potassium nitrate phosphate and ammonium chloride phosphate; potash fertilizer such as potassium chloride, potassium sulfate, potassium sodium sulfate, potassium sulfate magnesia, potassium bicarbonate and potassium phosphate; silicate fertilizer such as calcium silicate; magnesium fertilizer such as magnesium sulfate and magnesium chloride; calcium fertilizer such as calcium oxide, calcium hydroxide and calcium carbonate; manganese fertilizer such as manganese sulfate, manganese sulfate magnesia and manganese slag; boron fertilizer such as boric acid and borates; and iron fertilizer such as slag.

Agricultural compositions described herein include for example, fertilizers containing at least one fertilizer ingredient selected from nitrogen (N), phosphorus (P) and potassium (K), or a combination thereof are suitable.

Typical examples are NPK type (N—P₂O₅—K₂O) fertilizers and they include No.1 type such as 5-5-7 (hereinafter, the numbers mean weight percentages of N—P2O5—K2O) and 12-12-16; No.2 type such as 5-5-5 and 14-14-14; No.3 type such as 6-6-5 and 8-8-5; No.4 type such as 4-7-9 and 6-8-11; No.5 type such as 4-7-7 and 10-20-20; No.6 type such as 4-7-4 and 6-9-6; No.7 type such as 6-4-5 and 14-10-13; No.8 type such as 6-5-5 and 18-11-11; No.9 type such as 7-6-5 and 14-12-9; No.10 NP type such as 3-20-0 and 18-35-0; No.11 NK type such as 16-0-12 and 18-0-16; and No.12 PK type such as 0-3-14 and 0-15-15.

For example, “grams of nitrogen” generally means the amount of nitrogen present by weight in a fertilizer composition. For example, urea is 47% by weight N. Therefore, for example, 0.1 to 0.8 grams of N corresponds to about 0.21 to 1.7 grams of urea.

In some embodiments, the bead can be a homogeneous or heterogeneous mixture of one or more fertilizer components and a crop protection agent such as a pesticide. As an example of a heterogeneous mixture, the bead can be a core composition comprising a core of the fertilizer material and a shell comprising the pesticide. The shell can further comprise a polymer or a filled polymer. In addition to the fertilizer and the pesticide material, the agricultural composition can include inert agents, for example if needed to conform to a desirable shape and/or volume. In some embodiments, the polymer is, for example, polylactic acid, polyvinyl acetate, polyvinyl alcohol, co-polymers of polyvinyl acetate and polyvinyl alcohol, alginate, xanthan gum or a combination thereof. The pesticide can be applied directly to the fertilizer core, the polymer coated fertilizer core or, in other embodiments, can be formulated with a film-forming polymer. Filled polymers are a blend of polymers with one or more fillers. The fillers can be any of those known in the art, for example, starch, minerals, pigments, clays, plasticizers, stabilizers, the pesticide or a combination thereof. As an example of a homogeneous mixture, the fertilizer material and the pesticide can be thoroughly mixed and then compacted into beads comprising both the fertilizer and the pesticide.

The beads can be co-located with the propagule (such as for example, a seed) prior to planting the propagule, at the same time as the propagule is planted or shortly after or shortly before the propagule is planted. In some embodiments, especially in large scale commercial farming applications, the propagule and the bead can be co-located during the propagule planting operation. The beads can be of a variety of sizes, and for example, they are configured to flow through a planter and can range from about 3 mm to about 15 mm in diameter. The number of beads co-located with the propagule will depend on the amount of the pesticide required to provide the desired protective effect on the growing plant throughout its life. In some embodiments, one bead can be co-located with each propagule, while in other embodiments, one bead may provide nutrients and pesticides for more than one propagule.

The release timing can be determined, for example, by the soil type, soil pH, by type/blend of polymers used for the polymeric pouch, fillers used, by the thickness of the film, by the film uniformity, or by a combination of these or other factors. In some embodiments, the film thickness can be in the range of from 0.3, 0.4 to about 0.6, 0.7 mil. One mil (one thousandth of an inch) roughly equals 25.4 μm. In certain embodiments, the film thickness can be in the range of from about 5 micrometers to about 200 micrometers.

Pesticides can also be used as the agricultural composition or as a component of the agricultural composition. Suitable pesticides are those that are under the jurisdiction of the United States of America Federal Insecticide, Fungicide and Rodenticide Act (FIFRA). In some embodiments, the pesticide can be an insecticide, fungicide, nematicide, herbicide or a combination thereof. In further embodiments, the pesticide can be an insecticide, a fungicide or a combination thereof. The skilled worker is familiar with such pesticides, which can be found, for example, in Pesticide Manual, 15th Ed. (2009), The British Crop Protection Council, London. Certain herbicides are also included in order to control obligate hemiparasites of roots, for example, some species in the genera Orobanche and Striga which require a living host for germination and initial development. In some embodiments, a combination of two or more pesticides can be used. For example, both a fungicide and an insecticide can be present. In other embodiments, two different insecticides can be present, with or without the use of a fungicide. In other embodiments, the pesticide can be a systemic pesticide.

Suitable pesticides can include insecticides, for example, anthranilic diamides, N-oxides, or salts thereof, neonicotinoids, carbamates, diamides, spinosyns, phenylpyrazoles, sulfoxaflor or a combination thereof. In other embodiments, the insecticide can include, for example, thiodicarb, carbaryl, chlorantraniliprole, cyantraniliprole, methiocarb, thiram, or a combination thereof. The pesticide can have a Log Kow in the range of from any value between 1.2 and 3.0. In other embodiments, the log Kow can be any value in the range of from 1.22 to 2.9 such as from 1.25 to 2.9 or from 1.35 to 2.86. The water solubility of the pesticide at 25° C. can be between 0.5 and 150 mg/L, including any value or sub-range in between, such as 0.55 to 140 mg/L and 0.6 to 120 mg/L.

The anthranilic diamide class of insecticides contains a very large number of active ingredients and any of those can be used. Two specific examples of anthranilic diamides include chlorantraniliprole and cyantraniliprole. Both of these insecticides are available from E.I. du Pont de Nemours and Company, Wilmington, Del.

In some embodiments, the pesticide can be one or more anthranilic diamides, for example, those represented by Formula 1, or N-oxides, or salts thereof:

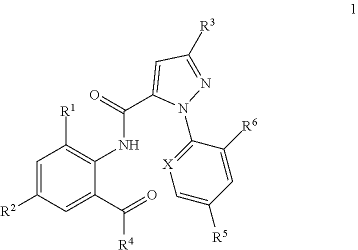

wherein
X is N, CF, CCl, CBr or CI;
R¹ is CH₃, Cl, Br or F;
R² is H, F, Cl, Br or —CN;
R³ is F, Cl, Br, C1 to C4 haloalkyl, C1 to C4 haloalkoxy or Q;
R⁴ is NR⁷R⁸, N═S(CH₃)₂, N═S(CH₂CH₃)₂, N═S(CH(CH₃)₂)₂;
R⁵ is H, F, Cl or Br;
R⁶ is H, F, Cl or Br;
each R⁷ and R⁸ is independently H, C1 to C6 alkyl, C3 to C6 cycloalkyl, cyclopropylmethyl or 1-cyclopropylethyl; and
Q is a —CH₂-tetrazole radical. Suitable embodiments for Q can include any structure having a formula according to Q-1 to Q-11 in TABLE 1 from U.S. Pat. No. 7,696,232, incorporated herein by reference.

In other embodiments, the insecticide can be one or more anthranilic diamides, for example, those represented by Formula 2, or N-oxides, or salts thereof;

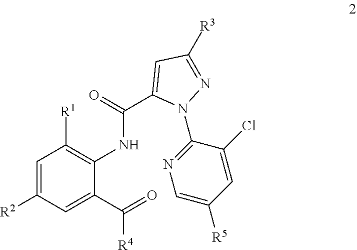

wherein
R¹ is CH₃, Cl, Br or F;
R² is H, F, Cl, Br or —CN;
R³ is F, Cl, Br, C1 to C4 haloalkyl, C1 to C4 haloalkoxy or Q;
R⁴ is NHCH₃, NHCH₂CH₃, NHCH(CH₃)₂, NHC(CH₃)₃, NHCH₂(cyclopropyl), NHCH (cyclopropyl)CH₃, N═S(CH₃)₂, N═S(CH₂CH₃)₂ or N═S(CH(CH₃)₂)₂; R⁵ is H, F, Cl or Br.

A specific structure wherein Q is Q-2 is shown below in Formula 3;

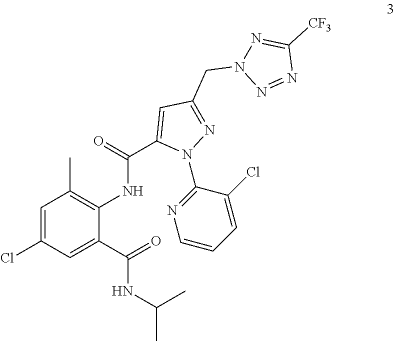 [SMILES: Cc1cc(Cl)cc(C(=O)NC(C)C)c1NC(=O)c1cc(Cn2nnc(C(F)(F)F)n2)nn1-c1ncccc1Cl]

In certain embodiments, the pesticides can be other known anthranilic diamide insecticides, for example, those described in U.S. Pat. No. 8,324,390, US 2010/0048640, WO 2007/006670, WO 2013/024009, WO 2013/024010, WO 2013/024004, WO 2013/024170 or WO 2013/024003. Specific embodiments from U.S. Pat. No. 8,324,390 can include any of those compounds disclosed as examples 1 through 544. Specific embodiments from US 2010/0048640 can include any of those compounds disclosed in Tables 1 through 68 or compounds represented by Chemical Formula 44 through 118. Each of the references to the above patents and applications are hereby incorporated by reference.

Nematicides can also be included as a pesticide. Suitable examples can include, for example, avermectin nematicides, carbamate nematicides, and organophosphorous nematicides, benomyl, benclothiaz, and a combination thereof. Nematicides also include nematicidally active biological organisms such as a bacteria or fungus. For example, Bacillus firmus, Bacillus cereus, Bacillus spp, Pasteuria spp, Pochonia chlamydosporia, Pochonia spp, and Streptomyces spp. A preferred nematicide according to an embodiment of the present invention is abamectin.

Fungicides can also be included. Suitable fungicides can include, for example, strobilurin fungicides, azole fungicides, conazole fungicides, triazole fungicides, amide fungicides, benzothiadiazole fungicides or a combination thereof. In other embodiments, the fungicides can include, azoxystrobin, metominostrobin, orysastrobin, paclobutrazol, acibenzolar-S-methyl, chlorothalonil, mandipropamid, thiabendazole, chlorothalonil, triadimenol, cyprodinil, penconazole, boscalid, bixafen, fluopyram, fenpropidin, fluxapyroxad, penflufen, fluoxastrobin, benthiavalicarb, benthiavalicarb-isopropyl, dimethomorph, flusulfamide, methyl thiophanate, triticonazole, flutriafol, thiram, carboxin, carbendazim or a combination thereof.

In some embodiments, the agricultural composition can also comprise one or more of a plant growth regulator. Suitable plant growth regulators can include, for example, potassium azide, 2-amino-4-chloro-6-methyl pyrimidine, N-(3,5-diclhorophenyl) succinimide, 3-amino-1,2,4-triazole, 2-chloro-6-(trichloromethyl)pyridine, sulfathiazole, dicyandiamide, thiourea, guanylthiourea or a combination thereof.

The agricultural composition can also comprise one or more Nod factors. As used herein, a “Nod factor” is a signaling molecule, typically produced by bacteria, for example, one or more of the Rhizobiaceae family, by means of which symbiotic bacteria capable of infecting plants and inducing the formation of root nodules are signaled. The bacteria infecting the roots produce nitrogen for the plants, while the plants carry away oxygen which would inhibit nitrogenase activity. Nod factors are known in the art and typically comprise compounds known as lipochitooligosaccharides (LCDs). These LCOs have an acylated chitin backbone of 3 to 5 N-acetylated glucosamine rings with one of the terminal glucosamine rings acylated by a fatty acid, for example, an unsaturated or polyunsaturated fatty acid.

The propagule can be any known propagule. In some embodiments, the propagule is a seed wherein the seed is a seed of wheat, durum wheat, barley, oat, rye, corn, sorghum, rice, wild rice, cotton, flax, sunflower, soybean, garden bean, lima bean, broad bean, garden pea, peanut, alfalfa, beet, garden lettuce, rapeseed, cole crop, turnip, leaf mustard, black mustard, tomato, potato, pepper, eggplant, tobacco, cucumber, muskmelon, watermelon, squash, carrot, zinnia, cosmos, chrysanthemum, sweet scabious, snapdragon, gerbera, babys-breath, statice, blazing star, lisianthus, yarrow, marigold, pansy, impatiens, petunia, geranium and coleus. Of note are seeds of cotton, corn, soybean and rice. Propagating materials co-planted with the beads in accordance to this disclosure also include rhizomes, tubers, bulbs or corms, or viable divisions thereof. Suitable rhizomes, tubers, bulbs and corms, or viable divisions thereof include those of potato, sweet potato, yam, garden onion, tulip, gladiolus, lily, narcissus, dahlia, iris, crocus, anemone, hyacinth, grape-hyacinth, freesia, ornamental onion, wood-sorrel, squill, cyclamen, glory-of-the-snow, striped squill, calla lily, gloxinia and tuberous begonia. Also suitable are rhizomes, tubers, bulbs and corms, or viable division thereof of potato, sweet potato, garden onion, tulip, daffodil, crocus and hyacinth. Propagating materials contacted with the beads of this disclosure also include stems and leaf cuttings. In some embodiments, the agricultural composition can be applied to an already growing plant, for example, a tree or a shrub, for example, an orchard tree, providing both nutrients and pesticides to the plant.

Non-limiting embodiments of the disclosure herein include:

### EXAMPLES

### Example 1

### Release of Nitrogen from Shrink Wrapped Urea Beads over 12 Weeks in Three Soils

Urea was purchased from Sigma Aldrich, and ground using a mortar and pestle. Two gram urea tablets were pressed using a hydraulic press with a 13 mm die (Hydraulic press was from Preco Hydraulic Press, Model PA2-1, S/N 1943, 9705 Commerce Parkway, Lenexa, Kans. 66219, USA). Three quarters of the tablets were coated with 3-4 mil (one thousandth of an inch) with poly(lactic acid) (PLA) (Ingeo 4032D, Natureworks LLC, Minnetonka, Minn., USA) by wrapping the tablet with film and then heating the film to shrink it around the tablet. The remaining tablets were coated, using the same procedure, with 3-4 mil poly (butylene succinate) (PBSA) (Bionolle 1003, Showa Denko, Japan) film. 13 mm bead has about 1600 mg/bead.

Soil was obtained from 3 locations in the Midwest that were later used for field trials—A Sable, silty-clay-loam was collected near Adair, Ill.; a, Maxfield (silty-clay-loam/Franklin (silt-loam) was collected near Marion, Iowa, and a Fruitland sand was collected near Fruitland, Iowa. 100 grams of soil were weighed into jars and made up to 30% moisture for the Sable and Maxfield/Franklin soils and 12% for Fruitland soil. Pellets were placed into a central area and the jars were sealed using an occlusive tape, to allow for air movement without the escape of moisture. Tablets coated with PBSA and PLA were evaluated in Sciota soil. Only PLA samples were evaluated in the Maxfield/Franklin soil and Fruitland soil. Sampling points were at 2, 4, 6, 7, 8, 9, 10, and 12 weeks. At this point, the beads were removed from the soil, dried, and their contents weighed to obtain a mass of urea left in the pellet. Soil extractions were carried out by using 500 mL of warm water to 100 g of soil, mixing on a shaker table overnight, and measuring the ammonium and nitrate concentrations using commercially available standard equipment. Urea concentrations were determined by calorimetric assay and UV plate reader analysis (BioAssay Systems, Hayward, Calif., USA). The amount of urea, ammonium, and nitrate extracted from the soil was summed and the total amount of nitrogen released was calculated. The results are summarized below in Table 1. The PBSA film degraded quickly in the Sable soil and showed faster release of urea than the urea tablets coated with PLA. The PLA coated tablets showed slow release in the first few weeks of the trial and then higher amounts of urea released at the end of the trial.

TABLE 1
Release of Nitrogen from Shrink Wrapped Urea Beads over 12 weeks

| | PBSA | | PLA | | PLA | | PLA | |
|---|---|---|---|---|---|---|---|---|
| | Sable | | Sable | | Fruitland | | Maxwell Franklin | |
| | Avg | STDEV | Avg | STDEV | Avg | STDEV | Avg | STDEV |
| Days | (%) | (%) | (%) | (%) | (%) | (%) | (%) | (%) |
| 14 | 15.8 | 4.1 | 11.8 | 6.5 | 7.0 | 6.1 | 5.7 | 2.0 |
| 28 | 65.1 | 11.5 | 4.0 | 4.5 | 4.4 | 2.5 | 8.7 | 7.0 |
| 42 | 88.5 | 13.6 | 9.4 | 0.5 | 4.7 | 2.5 | 8.5 | 4.2 |
| 49 | 96.0 | 7.0 | 17.9 | 7.5 | 20.2 | 16.2 | 6.2 | 4.1 |
| 56 | 100.0 | 0.0 | 12.8 | 3.6 | 16.1 | 5.5 | 9.5 | 3.3 |
| 63 | 100.0 | 0.0 | 12.5 | 5.1 | 26.2 | 21.0 | 29.5 | 18.7 |
| 70 | 100.0 | 0.0 | 30.6 | 0.0 | 54.4 | 29.3 | 23.8 | 11.9 |
| 84 | 100.0 | 0.0 | 43.3 | 36.2 | 29.2 | 10.0 | 48.4 | 44.8 |

### Example 2

### Preparation of PLA Coated Ammonium Sulfate Tablets by Shrink Wrapping

A poly(lactic acid) (PLA) blend was prepared by compounding 70% Ingeo PLA 4060 with 30% Ingeo PLA 4032 (Natureworks, Minnetonka, Minn.) in a twin screw extruder. Film was melt cast at two different thicknesses, 76.2 μm and 101.6 μm on a standard film processing line. Using a film stretcher, the films were stretched 2× in the machine direction and 2.5× in the transverse direction at Biax Labs, LLC in Rutherfordton, N.C. The films were slit into 3″ wide pieces and rolled. The ammonium sulfate tablets were packaged in the PLA film using a 3-seal vertical form fill commercially available machine. The subsequent PLA pouches containing one ammonium sulfate tablet were processed through a heat tunnel to shrink the polymer packaging around the tablet.

Ammonium Sulfate tablets were prepared as follows. Ammonium Sulfate as-received “Mini” grade (d50˜1630 μm, Honeywell Co, Hopewell Va.), was blended with 0.25 wt % magnesium stearate NF (KIC Chemicals, New Paltz, N.Y.) using sequential dilution in a v-cone blender. The ammonium sulfate was then processed into nominal 1.9 gram tablets using a motor driven single stage TDP-30 tablet press, purchased from Tabletpress.net, Athens, Ohio. Tablet punches had a standard curvature cup depth, consistent with Table 10, Tableting Specification Manual, 7th edition (American Pharmaceutical Association, 2005). Tablet hardness and dimensions were measured using a Sotax HT1 (Westborough, Mass.), consistent with method USP 1217. Typical 18 mm diameter tablets had an average mass 1.891 g±0.028 g, thickness 6.26 mm±0.18 mm and hardness 63 N±10 N. Typical 16 mm diameter tablets had an average mass 1.885 g±0.016 g, thickness 7.16 mm±0.03 mm and hardness 91 N±8 N.

### Example 3

### Release of Nitrogen from Spray Coated Urea Beads

Urea prill (Kirby Agri, Lancaster, Pa.), nominal d50˜3.6 mm, was ground and sieved to produce a free-flowing granular powder in the size range 250 um-1000 um (60 mesh to 18 mesh). 4800 grams of Urea prill were ground using a Retsch ZM200 mill (Verder Scientific, Newtown, Pa.), configured with a 6-tooth rotor and a 6 mm screen, operated at 6000 rpm. Mill discharge was processed though a stack of 8″ diameter sieves that are commercially available (W. S. Tyler, Mentor, Ohio) and the 3300 grams 18-60 mesh urea fraction was collected for further processing into tablets.

The 18-60 mesh urea was processed, without additional processing aids, into nominal 1.6 gram tablets using a motor driven single stage TDP-30 tablet press, purchased from Tabletpress.net, Athens, Ohio. Tablet punches had a standard curvature cup depth, consistent with Table 10, Tableting Specification Manual, 7th edition (American Pharmaceutical Association, 2005). Tablet hardness and dimensions were measured using a Sotax HT1 (Westborough, Mass.), consistent with method USP 1217. Typical 13 mm diameter tablets had an average mass 1612±5 mg, thickness 11.11±0.01 mm and hardness 484 N±22 N.

Urea tablets were spray coated with polymer solutions of polylactide (PLA) dissolved in methyl ethyl ketone (MEK). Polymer solutions were prepared by adding 80 g PLA (Ingeo 10361 D, Natureworks LLC, Minnetonka, Minn., USA) to a 1 L bottle containing 720 grams of MEK (Fisher Scientific, Pittsburgh, Pa.). The mixture was stirred and heated to 60 C until all polymer pellets dissolved. After cooling, 80 (verify this with Jonathon—suspect 20) mg of Pylakrome Red-Violet LX-9598 dye (Pylam Products, Tempe, Ariz.) was added to the solution.

Tablets were coated using a perforated pan, Laboratory Development Coating System [LDCS, Freund-Vector Corp, Marion, Iowa.] 969 grams of polymer solution were sprayed onto 1000 grams of tablets, to produce coated tablets with 9.7 wt % polymer relative to the core tablet. Samples were taken at intermediate time periods to generate samples with 2.6, 5.0, and 7.5 wt % coating relative to the core tablet. The pan coater was operated with a 1.5 L pan rotating at 22 rpm, with an inlet air flow of 30 cfm, 38° C., exhaust air temperature 30-32° C., and typical solution flow rate of 6 g/min.

### Example 4

### Spray Coating of Urea Tablets

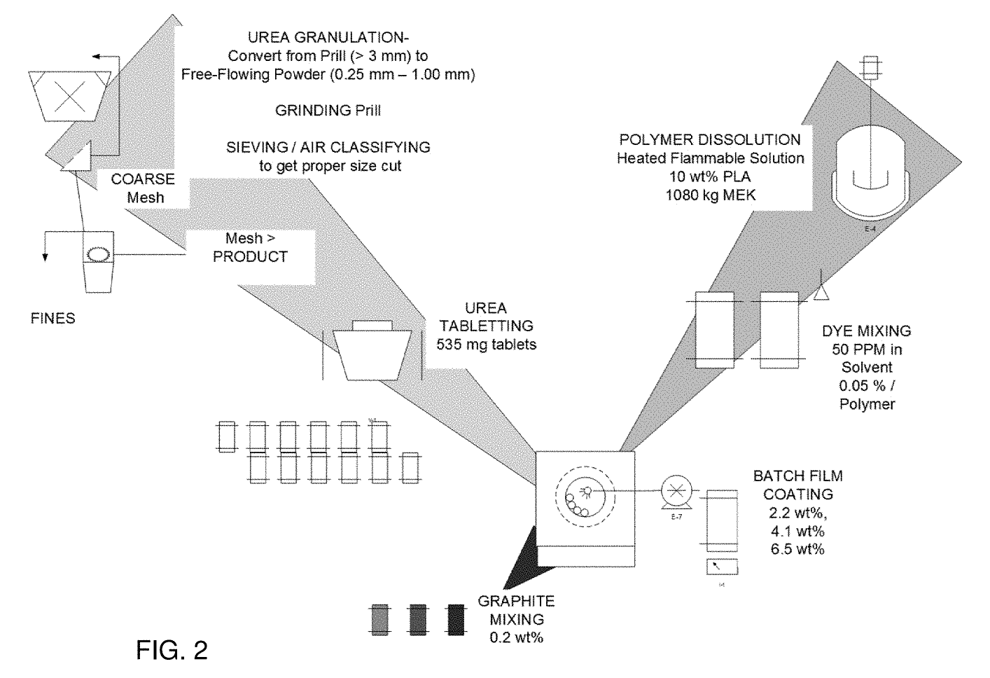

A schematic illustration is presented in FIG. 2. Urea prill (Kirby Agri, Lancaster, Pa.), nominal d50˜3.6 mm, was ground and sieved to produce a free-flowing granular powder in the size range 325 μm-1000 μm (40 mesh to 18 mesh). Urea was ground using a Mikropulverizer MP-1 mill (Hosokawa Micron Powder Systems, Summit, N.J.), configured with saddle hammers and a ¼″ screen, operated at 2250 rpm. Mill discharge was processed though a round separator with 18″ diameter screens, and the 18-40 mesh urea fraction was collected for further processing into tablets.

The 18-40 mesh urea was processed, without additional processing aids, into nominal 1.6 gram tablets using a motor driven single stage TDP-30 tablet press, purchased from Tabletpress.net, Athens, Ohio. Tablet punches had a standard curvature cup depth, consistent with Table 11, Tableting Specification Manual, 7th edition (American Pharmaceutical Association, 2005). Tablet hardness and dimensions were measured using a Sotax HT1 (Westborough, Mass.), consistent with method USP 1217. Typical 13 mm diameter tablets had an average mass 1612±5 mg, thickness 11.11±0.01 mm and hardness 484 N±22 N.

Urea tablets were spray coated with polymer solutions of polylactide (PLA) dissolved in methyl ethyl ketone (MEK). Polymer solutions were prepared by adding 72.8 lbs PLA (Ingeo 10361 D, Natureworks LLC, Minnetonka, Minn., USA) to a 200 gallon jacketed reactor containing 655 lbs MEK (Fisher Scientific, Pittsburgh, Pa.). The mixture was stirred and heated to 60° C. until all polymer pellets dissolved. After cooling and discharge to drums, 300 g Pylakrome Red-Violet LX-9598 dye (Pylam Products, Tempe, Ariz.) was mixed with 200 g MEK, and added to the solution.

Tablets were coated using a perforated pan coater. 21 kg of polymer solution were sprayed onto 42 kg of tablets, to produce coated tablets with 5.0 wt % polymer relative to the core tablet. The pan coater was operated with a 65 L pan rotating at 12 rpm, with an inlet air flow of 600 cfm, 35° C., exhaust air temperature 30-32 C, and typical solution flow rate of 70 g/min. During discharge from the coating pan, nominally 0.2 wt % graphite was blended with the tablets.

### Example 5

### Maize Yield Improvement Through Application of Delayed Release Fertilizer Beads in the Field

Field trials were conducted in Year 1 that included 24 separate treatments across a wide range of base N levels (Table 2.) The study was conducted at three diverse locations including a site near Marion, Iowa (DLN4, 3.5% organic matter, corn after soybean, highly productive soil, 6 reps), Fruitland, Iowa (2LN4, 1% organic matter, corn after corn, pure sand, irrigated, 6 reps) and near Sciota, Ill. (HSC4, 5% organic matter, corn after corn, poorly-drained, highly-productive soil, 4 reps) The experimental design was a randomized complete block design with a split-split plot treatment arrangement. The main plot was the N treatment rates (pre-plant and bead rates). The split plot was hybrid, and the split-split plot factor was thickness of poly lactic acid coating on the prototype beads. Beads were prepared as described in Example 4. In addition, replicates were used as a blocking factor.

TABLE 2
Description of experimental treatments. Each grouping of four consecutive
treatments was blocked and planted as a square unit in the field. The entire
treatment grid was replicated four or six times at each location.

| | | | Nitrogen | |
|---|---|---|---|---|
| | | | application using | Total |
| | | | beads with PLA | seasonal |
| Treatment Description | | Pre-Plant Nitrogen | coating | nitrogen |
| 1) | 60 lbs N/acre | 60 lbs N/acre applied | No additional N | 60 lbs N/acre |
| | preplant | as UAN | | |
| 2) | 60 lbs N/acre + 60 | 60 lbs N/acre applied | Bead with 2.6% PLA | 120 lbs N/acre |
| | lbs of N as prototype | as UAN | coating | |
| | 1 | | | |
| 3) | 60 lbs N/acre + 60 | 60 lbs N/acre applied | Bead with 3.8% PLA | 120 lbs N/acre |
| | lbs of N as prototype | as UAN | coating | |
| | 2 | | | |
| 4) | 60 lbs N/acre + 60 | 60 lbs N/acre applied | Bead with 5.0% PLA | 120 lbs N/acre |
| | lbs of N as prototype | as UAN | coating | |
| | 3 | | | |
| 5) | 120 lbs N/acre | 120 lbs N/acre applied | No additional N | 120 lbs N/acre |
| | preplant | as UAN | | |
| 6) | 120 lbs N/acre + 60 | 120 lbs N/acre applied | Bead with 2.6% PLA | 180 lbs N/acre |
| | lbs of N as prototype | as UAN | coating | |
| | 1 | | | |
| 7) | 120 lbs N/acre + 60 | 120 lbs N/acre applied | Bead with 3.8% PLA | 180 lbs N/acre |
| | lbs of N as prototype | as UAN | coating | |
| | 2 | | | |
| 8) | 120 lbs N/acre + 60 | 120 lbs N/acre applied | Bead with 5.0% PLA | 180 lbs N/acre |
| | lbs of N as prototype | as UAN | coating | |
| | 3 | | | |
| 9) | 180 lbs N/acre | 180 lbs N/acre applied | No additional N | 180 lbs N/acre |
| | preplant | as UAN | | |
| 10) | 180 lbs N/acre + 60 | 180 lbs N/acre applied | Bead with 2.6% PLA | 240 lbs N/acre |
| | lbs of N as prototype | as UAN | coating | |
| | 1 | | | |
| 11) | 180 lbs N/acre + 60 | 180 lbs N/acre applied | Bead with 3.8% PLA | 240 lbs N/acre |
| | lbs of N as prototype | as UAN | coating | |
| | 2 | | | |
| 12) | 180 lbs N/acre + 60 | 180 lbs N/acre applied | Bead with 5.0% PLA | 240 lbs N/acre |
| | lbs of N as prototype | as UAN | coating | |
| | 3 | | | |
| 13) | 240 lbs N/acre | 240 lbs N/acre applied | No additional N | 240 lbs N/acre |
| | preplant | as UAN | | |
| 14) | 240 lbs N/acre + 60 | 240 lbs N/acre applied | Bead with 2.6% PLA | 300 lbs N/acre |
| | lbs of N as prototype | as UAN | coating | |
| | 1 | | | |
| 15) | 240 lbs N/acre + 60 | 240 lbs N/acre applied | Bead with 3.8% PLA | 300 lbs N/acre |
| | lbs of N as prototype | as UAN | coating | |
| | 2 | | | |
| 16) | 240 lbs N/acre + 60 | 240 lbs N/acre applied | Bead with 5.0% PLA | 300 lbs N/acre |
| | lbs of N as prototype | as UAN | coating | |
| | 3 | | | |
| 17) | 60 lbs N/acre | 60 lbs N/acre applied | No additional N | 60 lbs N/acre |
| | preplant | as UAN | | |
| 18) | 60 lbs N/acre + 120 | 60 lbs N/acre applied | Bead with 2.6% PLA | 180 lbs N/acre |
| | lbs of N as prototype | as UAN | coating | |
| | 1 | | | |
| 19) | 60 lbs N/acre + 120 | 60 lbs N/acre applied | Bead with 3.8% PLA | 180 lbs N/acre |
| | lbs of N as prototype | as UAN | coating | |
| | 2 | | | |
| 20) | 60 lbs N/acre + 120 | 60 lbs N/acre applied | Bead with 5.0% PLA | 180 lbs N/acre |
| | lbs of N as prototype | as UAN | coating | |
| | 3 | | | |
| 21) | 120 lbs N/acre | 120 lbs N/acre applied | No additional N | 120 lbs N/acre |
| | preplant | as UAN | | |
| 22) | 120 lbs N/acre + 120 | 120 lbs N/acre applied | Bead with 2.6% PLA | 240 lbs N/acre |
| | lbs of N as prototype | as UAN | coating | |
| | 1 | | | |
| 23) | 120 lbs N/acre + 120 | 120 lbs N/acre applied | Bead with 3.8% PLA | 240 lbs N/acre |
| | lbs of N as prototype | as UAN | coating | |
| | 2 | | | |
| 24) | 120 lbs N/acre + 120 | 120 lbs N/acre applied | Bead with 5.0% PLA | 240 lbs N/acre |
| | lbs of N as prototype | as UAN | coating | |
| | 3 | | | |

Each main N plot consisted of 8 sub-plots and each sub-plot included four rows (30″ spacing) that were 16.9 feet in length. The arrangement of experimental units facilitated convenient mechanical application of the pre-plant N treatments.

The main N treatments were randomized within each replicate, the hybrid entries were randomized within the main factor unit, and the sub-plot factor was randomized within the blocked plot square formed by each hybrid entry. This arrangement was necessary to match application equipment widths and minimized spatial variation and random field effects within the trial.

Non-nitrogen fertilizer (P, K, and micronutrients) were applied using standard practices in the area to ensure other nutrients were not limited. Pre-plant nitrogen rates listed in Table 2 were applied as liquid urea ammonium nitrate (UAN) either in a 32% or 28% nitrogen by weight formulation. Preplant N applications were made just before planting at the Macomb and Marion sites using a modified Prepmaster from Bigham Brothers Inc. (Lubbock, Tex.) This applicator allowed for immediate incorporation of UAN treatments. UAN treatments in Fruitland, Iowa were made using a standard agricultural sprayer with a 20′ boom. The common application width of the two tools allowed for similar planting arrangements. In lieu of immediate tillage at Fruitland, Iowa, the UAN treatments were irrigated with 0.25″ of irrigation from the center pivot irrigator that serves the site.

The trial sites were planted with an eight row research planter with vacuum plate metering. The target planting rate in each of the three planting locations was targeted at approximately 34,000 plants per acre, achieved by precision planting and thinning to stand post emergence where necessary. The specific hybrids planted in the trial are shown in Table 3, along with some of their pertinent attributes. The hybrids were chosen for their expected diversity in environmental response. Commercial Hybrid 1 is a hybrid that takes advantage of resources to push top end yield and generally does not perform well where inputs are limiting. In contrast, Commercial Hybrid 2 is a drought tolerant hybrid that is more conservative with resources and performs well in limiting environments. Suitable CRMs (comparative relative maturity) include about 70-140.

TABLE 3
Hybrid entries and associated characteristics included in trial.

| | GDUs to Physiological | |
|---|---|---|
| Hybrid | Maturity | Market Segment |
| Commercial | 2730 | Midwest high-yield |
| Hybrid 1 | | |
| Commercial | 2580 | Western corn belt, water |
| Hybrid 2 | | limited |

The beads themselves were pressed from ground and sized urea prill. Each 13 mm diameter bead contained the equivalent rate of 60 lbs N/acre when applied at a rate of 1 bead/plant within the row. To achieve the 120 lb N bead rate, two beads were applied for each plant. Prior to application in the field, the beads were prepared by tumbling in a chamber while being sprayed with poly lactic acid (PLA), held in a solution of methyl ethyl ketone until the desired thickness (as determined by percent weight coating to total bead weight ratio) was reached. The beads were then packaged by count into envelopes. Individual envelopes contained the appropriate number of beads to match the target 60 lb N or 120 lb N bead treatments. A modified cone planter was used to apply the beads immediately following planting of the seeds. Individual packets of beads were arranged such that the operators could dump them consecutively into the application tool as the applicator was moved over the plots. Dry fertilizer knives fixed to the bottom of the cone distributors injected the beads approximately four inches to one side of the seed row, and approximately four to five inches below the soil surface.

Pests were controlled with common practices to control weed and insect pressures throughout the year. The Fruitland, Iowa site soil moisture was amended with overhead irrigation to minimize drought stress, while the remaining two sites were dryland (natural rainfall only). Post flowering, a stay green rating was taken approximately once a week beginning around R3 to quantify green leaf area retention of treatments as they approached physiological maturity. When grain moisture fell below 30%, the trial was combine harvested (middle two rows of 4-row plot), collecting plot grain weight and moisture simultaneously. These weights are standardized to 15% moisture yields calculated in bu/acre, based on individual plot area.

Results: Mixed model analysis was done using SAS Enterprise Guide 6.1. Generally, location, and soil treatment (the concatenation of pre applied nitrogen and bead applied nitrogen) were held as fixed effects, with rep, range, and plot, being random effects. There was a significant location effect on response (Table 4) suggesting different soils, environments; cropping histories across the 3 locations had an impact on the efficacy of the bead N applications. This indicates treatment values are location dependent and thus must be evaluated for each location. Since the overall yield performance of these two hybrids was different (Hybrid 1 yielded higher than Hybrid 2), a significant F value associated with GE was observed. The GE×Soil Treatment interaction F value was much less significant, however, so we pooled bead N treatment data across hybrids. Finally the sub-plot factor of the individual PLA coatings was not statistically significant from each other in most cases within individual N treatment, and so the 3 PLA thicknesses were usually pooled to determine an overall effect of bead N compared to the standard pre-plant N treatments.

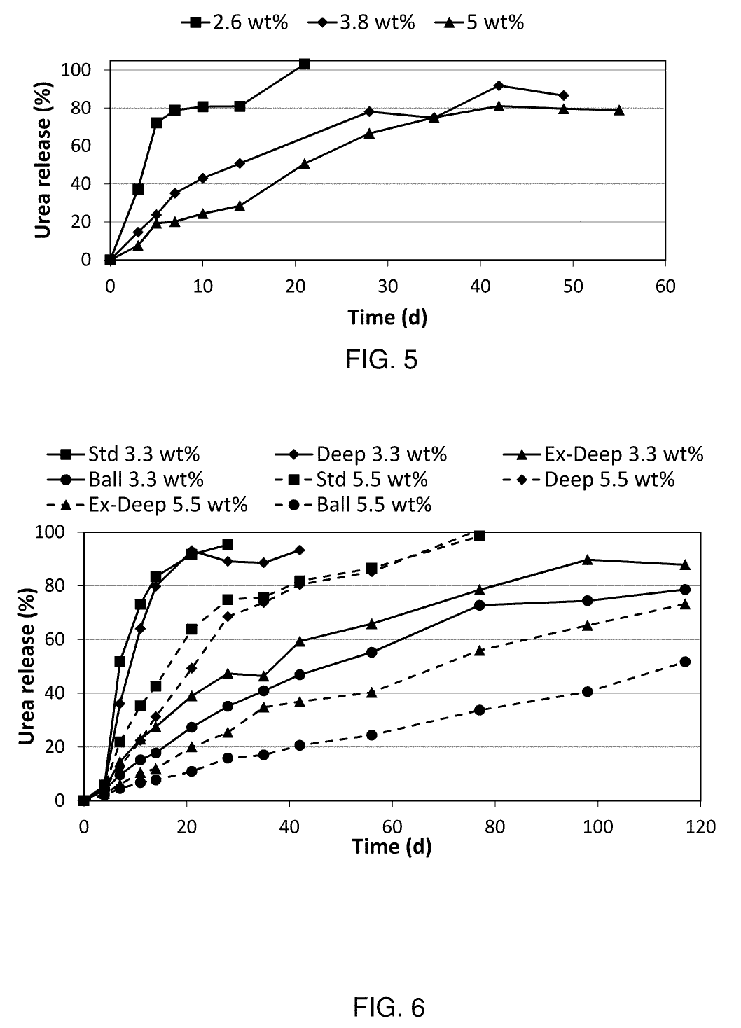

Results for individual locations are shown in Table 4. Within a location, yield data are clustered by total seasonal N amounts. After separating the highest yielding site, Location 3 (corn after soy), correlations between Location 1 and Location 2 (both corn after corn) are robust. The amount of residual nitrogen available in those two locations was lower than in Location 3. Yield values clustered by coating thickness is presented in Table 5. Cumulative total N release for a variety of fertilizer compositions were measured by in vitro soil analysis (FIG. 5).

TABLE 4
Year 1 Corn Field Trials by Extended Release Nutrient Tablets

| | Location 1 - | Location 2 - | Location 3 - |
|---|---|---|---|
| Soil Treatment | Avg. Yield | Avg. Yield | Avg. Yield |
| (lbs) of N | bu/acre | bu/acre | bu/acre |
| 60 Preplant (base N) | 83.1 | 34.8 | 191.5 |
| 120 Preplant (base N) | 143.8 | 42.1 | 218.7 |
| 60 (base N) + 60 | 125.4 | 65.1 | 202.7 |
| (coated tablet) | | | |
| 180 Preplant (base N) | 149.1 | 49.7 | 226.9 |
| 120 (base N) + 60 | 178.3 | 69.8 | 225.7 |
| (coated tablet) | | | |
| 60 (base N) + 120 | 160.7 | 91.5 | 217.5 |
| (coated tablet) | | | |
| 240 Preplant (base N) | 125.4 | 56.3 | 220.3 |
| 180 (base N) + 60 | 182.8 | 80.6 | 221.5 |
| (coated tablet) | | | |
| 120 (base N) + 120 | 186.3 | 105.1 | 222.5 |
| (coated tablet) | | | |
| 240 (base N) + 60 | 173.2 | 87.7 | 217.3 |
| (coated tablet) | | | |

The individual PLA coatings were tested for significant interaction with yield at each site. The corn-on-corn locations, Locations 1 and 2, were compared in a multi-location comparison. The nitrogen release profiles were measure in three field locations (FIGS. 6, 7 and 8).

Year 1 beads were nominally 1600 mg, 13 mm diameter, and 11.1 mm thickness (standard curved shape) and average data from an evaluation run showed ranges of about 1612 (5) mg, 13.02 (0.03) mm diameter, 11.11 (0.01) mm thickness, where the number in parentheses is the standard deviation. The mass and dimensions of the final bead varied with the amount of polymer coating.

For Year 1 field trials, the tablets containing about 1600 mg urea in three different PLA coating thickness were used. The PLA coating thickness was 2.6 weight %, or 3.8 weight % or 5.0 weight % of the total tablet. Calculated tablet mass was 1641.6 mg for the 2.6% coating; 1660.8 mg for the 3.8% coating and 1680 mg for the 5.0% coating. All three coatings thickness beads contain 736 mg N/bead, which constitutes roughly about 44% weight % N/bead.

Data collected during Year 1 at three unique locations (corn following soybean, corn following corn in at a low organic matter soil, and corn following corn at a high organic matter location) confirmed the value of delaying delivery of some N until later in the development of corn. The high early season rainfall at the Sciota, Ill. location (Location 1) likely increased the overall response to Bead N at that location. During the season, that location received about 3× normal seasonal rainfall and resulted in N leaching and denitrification. However, this provides evidence of the “insurance” potential Bead N could provide in regions with unpredictable weather patterns. Global climate change may trigger a higher probability of these weather extremes in this century. Also, soil type played an important role in the results at the Fruitland, Iowa location (Location 2). The high sand content of the soil allows for rapid leaching of N from the system. While this location is a very extreme soil type relative to the rest of the Midwest, all well-drained soils do have the potential for excessive N loss. The neutral response to Bead N at the Marion, Iowa corn-on-soy location (Location 3) confirms that delayed N release is likely to add less value in environments where N is less limiting. That location was planted relatively late, however, and that later planting may have limited some potential N response that may have been observed with an earlier planting date. In rotational cropping systems, one can expect the N response to be reduced and factors other than N can limit crop yield.

TABLE 5
Average yield variation in bu/acre for beads coated
with different thickness of the polymer. 2.

| | Coating | Coating | Coating |
|---|---|---|---|
| Soil Treatment | thickness 2.6 | thickness 3.8 | thickness 5.0 |
| (lbs) of N | (thin) | (medium) | (thick) |
| 60 (base N) + 60 | 66.2 | 62.5 | 66.5 |
| (coated tablet) | | | |
| 120 (base N) + 60 | 64.2 | 72.3 | 73.0 |
| (coated tablet) | | | |
| 60 (base N) + 120 | 79.5 | 100.2 | 94.6 |
| (coated tablet) | | | |
| 180 (base N) + 60 | 75.5 | 81.7 | 84.6 |
| (coated tablet) | | | |
| 120 (base N) + 120 | 99 | 109.3 | 107.0 |
| (coated tablet) | | | |
| 240 (base N) + 60 | 82.2 | 90.2 | 90.8 |
| (coated tablet) | | | |

Overall, our data show that the availability of more N late in the season can increase corn yields up to 40 bu/acre, depending on the soil type, crop rotation, and environmental conditions. Future work should focus on determining the Bead N response across a larger set of locations with greater diversity for those three factors.

### Example 6

### Field Trials with Polymer Coated Tablets/Beads (Year 2)

Field trials were conducted to compare the performance of polymer coated urea beads/tablets applied at planting to other nitrogen applications at planting as well as side-dress applications in-season (Year 2). Slow release characteristics of the polymer coated urea tablets were evaluated to determine whether they would provide protection against typical environmental loss of N, which occurs prior to later stages of plant growth, when N demand by the crop and uptake from the soil are high. In an aspect, improved performance of the slow release tablets was measured as a grain yield increase compared to normal release standard N applications.

Studies were conducted in representative commercial maize fields in several locations with varying climate and soil conditions in the mid-west. Base rates of nitrogen fertilizer, ranging from 100 to 200 lbs N acre⁻¹ were broadcast applied prior to planting the corn crop (Table 7). In this trial, PLA was the polymer. Polymer coated urea beads were applied on the day of corn seed planting below the soil surface in a band placed about 6 inches away from the seed row. Three polymer coated prototypes were applied in separate treatments, referred to as “Thin”, “Medium” and “Thick”, corresponding to contrasting polymer coating thicknesses, designed to release the urea at different stages of corn development. PLA-coated urea tablets which are coated at three different ratios 2.2%, 4.2%, and 6.5% based on the mass ratio of PLA to urea. In this trial, “thin” corresponds to 2.2%; “medium” corresponds to 4.2%; and “thick” corresponds to 6.5%. In all bead treatments, 60 lbs N/acre was applied. To provide the contrast of interest with the same total N load, 60 lbs N acre−1 in the form of an uncoated urea bead was also applied to the “Control” plots. In both the uncoated and polymer coated bead plots total N load included the base N applied pre-plant+the 60 lbs urea N applied at planting. Total N load across locations ranged from 160 lbs N acre−1 to 260 lbs N acre⁻¹. In the Control treatment the 60 lbs N of uncoated urea was subject to immediate release and dispersion into the soil making it vulnerable to environmental loss. In contrast, the 60 lbs N of polymer coated urea was protected from environmental loss until the coating began to release the urea. Performance of the polymer coated urea treatments across 12 locations is summarized in Table 7. In the majority of locations, small positive impacts on yield were observed. It was evident that the Medium and Thick coatings performed more consistently than the Thin coating.

TABLE 6
Base rate N applications applied at research
locations in the Midwest, USA during Year 2.

| | | | Total N rate (base + 60 |
|---|---|---|---|
| | Base N | | lbs N acre⁻¹ urea control |
| Locations | rate | N product** | or polymer coated bead) |
| WI | 125 | Anhydrous | 185 |
| | | Ammonia | |
| MN | 120 | Urea | 180 |
| MN | 120 | Urea | 180 |
| IA | 120 | UAN + DAP | 180 |
| IN | 180 | UAN | 240 |
| IL | 100 | UAN | 160 |
| IL | 120 | UAN | 180 |
| IL | 140 | UAN | 200 |
| IA | 200 | UAN | 260 |
| IA | 120 | UAN | 180 |
| IA | 150 | UAN | 210 |
| NE | 120 | UAN | 180 |
| IL | 120 | UAN | 180 |
| IL | 175 | Anhydrous | 235 |
| | | Ammonia | |

**The breakdown analysis on a percent N-P-K basis are as follows: Anhydrous Ammonia (92-0-0), Urea (46-0-0), UAN (28-0-0), DAP (18-46-0).

In a separate study, the Medium and Thick polymer coated urea beads were compared to additional commercial and experimental supplemental N treatments in order to rank performance. In this study, the Control treatment was a supplemental N application using urea ammonium nitrate (UAN) (60 lbs N acre−1), applied at the V5 stage of development. This is the most common supplemental N treatment used when growers plan to split their N applications between pre-plant broadcast, and in-season side-dress N. This study was conducted at six locations and the summary of treatment yields is shown in Table 9. Some of the treatments yielded more than the V5 UAN treatment, while others yielded less. Yield ranking of the treatments was: Medium>Thick>ESN (broadcast and incorporated at planting)>Medium Broad (beads broadcast and incorporated at planting, rather than placed in a band below the soil surface)>UAN at growth stage V14>UAN at growth stage V5 (Control)>Combo Broad (Medium and Thick broadcast and incorporated at planting, rather than placed in a band below the soil surface)>Thick Broad(broadcast and incorporated at planting, rather than placed in a band below the soil surface)>UAN at growth stage R1. From these data, one must conclude that there is differential value of the Medium and Thick polymer coated urea treatments, compared to all other supplemental N treatments. The numeric increase in yield compared to the ESN commercial product confirms an additional advantage of the tested polymer coated urea products compared to the ESN prills. The ESN beads used were commercially available Agrium ESN, polymer coated urea 44-0-0 that contains 44% Nitrogen.

Year 2 beads were nominally 535 mg, 9.525 mm diameter×7.4 mm thickness (extra deep cup shape). Average data from an evaluation run showed—530 (9) mg, 9.60 (0.04) diameter mm, 7.41 (0.08) mm thickness, where the numbers within the parenthesis indicate standard deviation.

TABLE 7
Yield increase for three coated fertilizer products
relative to an uncoated control averaged across 15
maize hybrids grown at 12 locations in Year 2.

| | Thin | Medium | Thick |
|---|---|---|---|
| Locations | ----------------bu acre⁻¹-------------- | | |
| 1 | −3.9* | 10.0* | 11.1* |
| 2 | 4.0* | 5.1* | 5.9* |
| 3 | 0.9 | 7.0* | 3.0 |
| 4 | 1.4 | 4.0* | 2.0 |
| 5 | 3.0 | 3.1 | −0.2 |
| 6 | −2.0 | 1.2 | 2.2 |
| 7 | 1.9 | −0.5 | −1.5 |
| 8 | −1.3 | −1.7 | 2.0 |
| 9 | 0.4 | 0.3 | −2.2 |
| 10 | −5.3* | 2.7 | 0.9 |
| 11 | −2.8 | 1.9 | −1.9 |
| 12 | −2.6* | −2.0 | −1.2 |

*indicates significance at p ≤ 0.10

TABLE 8
Yield change for eight N treatments that included coated
fertilizer products and UAN application relative to
application of UAN at V5 averaged across six maize
hybrids grown at six environments in Year 2.

| | Yield |
|---|---|
| Treatment | bu acre⁻¹ |
| Medium | 5.9* |
| Thick | 5.5* |
| ESN (commercial urea prills) | 3.7* |
| Medium Surface application | 0.8 |
| UAN applied at V14 | 0.8 |
| Thin + Medium + Thick | −0.8 |
| Thick Surface application | −2.0 |
| UAN applied at R1 | −2.5* |

*indicates significance at p ≤ 0.10

TABLE 9
Yield change for a coated fertilizer product (across thicknesses
in Year 1 and medium thickness in Year 2) relative to an uncoated
fertilizer control grown under multiple N rates at three locations
during Year 1 and at 12 locations during Year 2 for a total of
29 environmental comparisons averaged across hybrids.

| | Yield |
|---|---|
| Locations | bu acre⁻¹ |
| 1 | 61* |
| 2 | 57* |
| 3 | 49* |
| 4 | 42* |
| 5 | 29* |
| 6 | 27* |
| 7 | 24* |
| 8 | 23* |
| 9 | 20* |
| 10 | 12* |
| 11 | 10* |
| 12 | 7* |
| 13 | 5* |
| 14 | 4* |
| 15 | 3 |
| 16 | 3 |
| 17 | 2 |
| 18 | 2 |
| 19 | 2 |
| 20 | 1 |
| 21 | 1 |
| 22 | 0 |
| 23 | −1 |
| 24 | −1 |
| 25 | −2 |
| 26 | −2 |
| 27 | −9 |
| 28 | −16* |
| 29 | −18* |

*indicates significance at p ≤ 0.10

Data combined over a number of studies in year 1 and year 2 are shown in Table 9. Across 29 environments (consisting of multiple N rates at a location in Year 1 or unique locations in Year 2), where a number of N rates were evaluated, the polymer coated urea (across polymer thicknesses in Year 1 and the medium bead in Year 2) provided a net increase of 11.4 bu acre⁻¹. Many factors including rainfall, soil type, and crop history and yield play a role in the relative performance of the polymer coated beads across these locations.

### Example 7

### Agricultural Composition Planting Using Pneumatic Planters

Pneumatic planters with one or more seed meters are in commercial use to plant seeds in the ground at various depth and spacing. Such planters configured to plant the compositions described herein are useful to place the compositions at a desired distance from the seeds and at desired depth ranges. The seeds are generally singulated and metered by a seed metering disc with pockets, holes or combinations thereof, and commonly use a vacuum or positive air pressure mechanism. In an embodiment, such seed planter is configured to plant seeds and/or compositions as described herein.

For certain embodiments that include combinations of seed populations and row spacings, the agricultural composition is equally spaced with seed in a furrow and the agricultural composition in an adjacent furrow. In an embodiment, if for example, there are two or more planter units driven by a common drive mechanism, product metering discs may be positioned relative to each other in order to optimize agricultural composition placement at a desired spacing with the immediately adjacent seeds. Obtaining appropriately spaced agricultural composition with the seed in adjacent twin rows, mechanical adjustments to the planters may be needed to synchronize the dispensing of both the seeds and the agricultural compositions disclosed herein. Such modifications include for example, offsetting the meters the plant the seeds by a required spacing from one another such as for example, chain adjustments or rotating the axles.

In certain embodiments, two metering discs are functionally associated such that seed and agricultural composition (e.g., fertilizer, insecticides, fungicides) are dispensed such that seed and fertilizer are alternately spaced at approximately the same distance between each other in a twin row seeding configuration. In this set-up, when one meter dispenses seed in the first row, the second meter dispenses fertilizer in the second row, either simultaneously or within a reasonable amount of time within each other. In addition, when one meter places fertilizer in the first row, a second meter places seed in the second row. This results in an alternating dispensing and placement of seed and fertilizer in a staggered pattern in a twin row seeding configuration.

A product planter described herein places the agricultural compositions at approximately equal distances between seeds within a seed furrow and/or between seed furrows. In an embodiment, the planting units that dispense both seed and fertilizer use the same metering device to generate sufficiently spaced fertilizer and seed. The rows may be evenly spaced or irregular. The seeds and the agricultural compositions relative to the seeds may not be placed at a uniform distance. In certain embodiments, the agricultural composition may be irregularly placed with respect to uniformly placed seeds. The placement of agricultural composition described herein may not be precise in certain configurations. The seeds and fertilizer may be dispensed on the top surface of the ground or into the ground, and each may be placed at different depths. Fertilizers alternately spaced from the seeds help maximize nutrient availability for each seed. Targeted placement of nutrients allows a greater amount of fertilizer or a crop protection chemical to be applied at planting then is usually applied with a traditional starter fertilizer program or a seed treatment program.

Seeds may be dispensed in alternating patterns in adjacent rows. For example, seeds are planted in twin rows, where the fertilizer granules are in a row spaced between each row of seeds of a twin row. In certain embodiments, seeds are planted in equally spaced twin rows with the fertilizer intermittently spaced within each seed row. In another embodiment, the fertilizer placement is such that the fertilizer is approximately equally spaced from adjacent seeds of each row of a twin row. This configuration permits a single row of fertilizer compositions to provide nutrients to two adjacent seed rows.

Placement of the agricultural compositions described herein improve nutrient use efficiency by minimizing loss of fertilizers and making applied supplemental nutrients more available for plants.

### Example 8

### Beads Containing Nutrient for a Yield Gain and Crop Protection Active Ingredient for Bioefficacy

Preparation of a Polylactide-Coated Tablet of Urea with Azoxystrobin. 1 kg of finely divided urea is blended with 1.1 g of azoxystrobin. The solids are mixed by tumbling to give an intimate blend of the two constituents, with blending assured by assaying individual aliquots of the blend. The resulting table is then pressed into tablets using a hydraulic press, using a single stage mechanical tablet press applying 5 kN force to give pressed tablets with an average mass of 535 mg, 9.6 mm diameter, and 7.4 mm thickness. The resulting tablet is then coated with polylactide to give a coated tablet that is 4.0 wt. % polylactide. Urea tablets are spray coated with polymer solutions of polylactide (PLA) dissolved in methyl ethyl ketone (MEK). Polymer solutions are prepared by adding 80 g PLA (Ingeo 10361 D, Natureworks LLC, Minnetonka, Minn., USA) to a 1L bottle containing 720 grams of MEK (Fisher Scientific, Pittsburgh, Pa.). The mixture is stirred and heated to 60 C until all polymer pellets dissolved. Tablets are coated using a perforated pan, Laboratory Development Coating System (LDCS, Freund-Vector Corp, Marion, Iowa). 400 grams of polymer solution is sprayed onto 1000 grams of tablets, to produce coated tablets with 4.0 wt % polymer relative to the core tablet. The pan coater is operated with a 1.5 L pan rotating at 22 rpm, with an inlet air flow of 30 cfm, 38° C., exhaust air temperature 30-32° C., and typical solution flow rate of 6 g/min. The resulting tablet is planted adjacent to a crop seed and is expected to provide effective bioefficacy against mid-season pests that are sensitive to azoxystrobin, with sufficient mid-season nitrogen to provide a yield gain.

### Example 9

### Soil Release Profiles for Crop Protection Agents

Beads and tablets containing crop protection agents were prepared. A variety of beads were produced, their soil release profiles and leaf concentration after uptake into plants were also determined. A brief description of the beads used are as follows.

TABLE 10
Al content determination for extruded beads:

| | Expected | Average | |
|---|---|---|---|
| | Al per | Al per | |
| | Bead | Bead | Standard |
| Bead Description | (mg) | (mg) | Deviation |
| I-H, 90% PBSA, 10% Calicum Phosphate, | 0.65 | 0.752182 | 0.0173204 |
| Clothianidin | | | |
| I-F, I-J, 70% PBSA, 20% Corn Starch, 10% | 0.69 | 0.774142 | 0.0256461 |
| Calcium Phosphate, Clothianidin | | | |
| I-E, I-I, 70% PBSA, 20% Corn Starch Solids, | 0.69 | 0.643985 | 0.0239541 |
| 10% Calcium Phosphate, Thiamethoxam | | | |
| I-G, 90% PBSA, 10% Calcium Phosphate, | 0.69 | 0.632749 | 0.0151339 |
| Thiamethoxam | | | |
| F-E, 50% PBSA, 40% Corn Starch, 10% | 0.92 | 0.687 | 0.0437958 |
| Calcium Phosphate, Flutriafol | | | |
| F-D, 50% PBSA, 40% Corn Starch, 10% | 1.07 | 1.196843 | 0.0102814 |
| Calcium Phosphate, Azoxystrobin | | | |

TABLE 11
Active ingredient content determination for 535 mg coated tablets:

| | Expected | Measured | |
|---|---|---|---|
| | Active Mass | Active Mass | Standard |
| Tablet Description | (mg) | (mg) | Deviation |
| I-O PLA coated Urea 535 mg/L with | 0.7 | 0.907309917 | 0.049544071 |
| Thiamethoxam on outside | | | |
| I-P PLA coated urea 535 mg/L with | 0.7 | 1.088585345 | 0.063035885 |
| Clothianidin on the outside | | | |
| F-F Flutriafol coated on a 535 mg/L PLA | 1.1 | 0.609654057 | 0.163903266 |
| tablet | | | |
| F-B Azoxystrobin coated onto a 535 mg/L | 1.1 | 0.822943077 | 0.129725596 |
| urea/PLA tablet | | | |
| F-G Uncoated 535 mg 7:1 urea/struvite | 1.1 | 0.894844353 | 0.099153708 |
| Azoxystrobin tablet | | | |
| I-C Urea/thiamethoxam PBSA 4 mil tablet - | 0.7 | 0.863873748 | 0.077425634 |
| film wrapped | | | |
| I-D Urea/Clothianidin PBSA 4 mil tablet | 0.7 | 0.80006457 | 0.072981126 |
| film wrapped | | | |

TABLE 12
Brief description of the beads and tablet prototype used for trials

| Prototype | Active | Short Name | Description |
|---|---|---|---|
| I-C | Thiamethoxam | Thia PBSA-Urea | 4 mil PBSA wrapped urea tablet |
| I-D | Clothianidin | Clo PBSA-Urea | 4 mil PBSA wrapped urea tablet |
| I-G | Thiamethoxam | Thia PBSA (NO Starch) | 90/10 PBSA/CaHPO4 bead (not wrapped, no |
| | | | starch) |
| I-H | Clothianidin | Clo PBSA (NO Starch) | 90/10 PBSA/CaHPO4 bead (not wrapped, no |
| | | | starch) |
| I-I | Thiamethoxam | Thia PBSA 20% Starch | 70/20/10 PBSA/Starch/CaHPO4 bead (not |
| | | | wrapped) |
| I-J | Clothianidin | Clo PBSA 20% Starch | 70/20/10 PBSA/Starch/CaHPO4 bead (not |
| | | | wrapped) |
| I-L | none | Urea + PLA | PLA coated urea 535 mg/L - no active |
| I-K | none | PBSA | 70/20/10 PBSA/Starch/CaHPO4 bead (not |
| | | | wrapped, no active) |
| I-P | Clothianidin | Clo PLA Urea | PLA coated urea 535 mg/L with Clothianidin on |
| | | | the outside |
| I-M | Thiamethoxam | Uncoated urea/thia | uncoated urea/pressed with thiamethoxam |
| | | | formulation |
| I-M-2 | Thiamethoxam | Uncoated urea/thia | Uncoated Thiamethoxam Urea Tablet |
| I-O | Thiamethoxam | urea/PLA coated with | urea/PLA coated with thiamethoxam on outside |
| | | thia | |
| I-N | Clothianidin | Uncoated urea/clo | uncoated urea/pressed with clothianidin |
| | | | formulation |
| I-N-2 | Clothianidin | Uncoated urea/clo | uncoated clothianidin urea tablet |
| F-B | Azoxystrobin | Azoxy PLA-Urea | Formulation coated 2.2 wt % PLA/urea tablet |
| F-D | Azoxystrobin | Azoxy PBSA 40% | 50/40/10 PBSA/Starch/CaHPO4 bead |
| | | Starch | |
| F-E | Flutriafol | Flu PBSA 40% Starch | 50/40/10 PBSA/Starch/CaHPO4 bead |
| F-F | Flutriafol | Flu PLA-Urea | Formulation coated 2.2 wt % PLA/urea tablet |
| F-G | Azoxystrobin | Azoxy | Urea/Struvite/Maltrin tablet (not coated) |
| | | Urea/Struvite/Maltrin | |

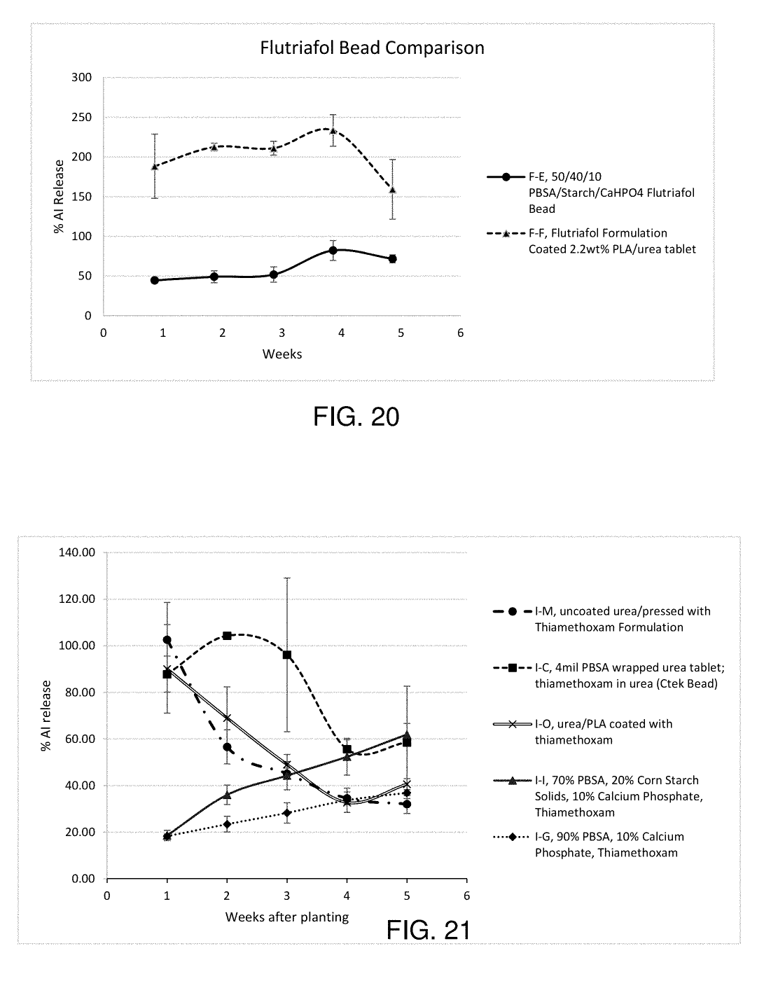

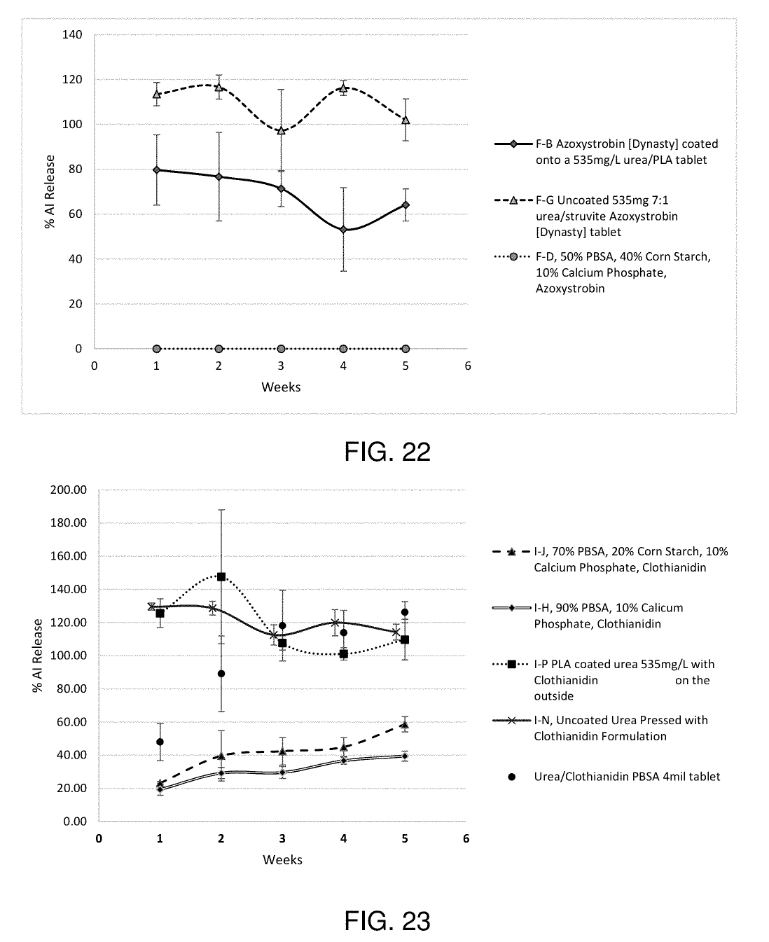

Water content of Stine soil used in this experiment, was measured. Once the water content was determined it was adjusted to 27wt % water, which is field capacity, prior to planting beads. Next, the 5-week static soil study was set up by preparing three jars with soil for each bead prototype at each time point. The amount of soil depends upon the solubility of the active in water to be screened. The beads were then planted in the soil and the jars were covered with tape to prevent water evaporation. The experiment was sampled weekly over the 5-week timeframe. Sampling involved initially removing the beads from the soil. Then the soil was transferred to a bottle and extracted with acetonitrile to remove any of the crop active that was released into the soil. The bottles were then vortexed, sonicated, and placed on a shaker table for 3 days to ensure all the crop active was extracted. After three days, a sample was taken from each bottle, filtered and run on a HPLC with or without a MS to determine the concentration of crop active in the soil, using standard protocols. Prior to running these samples, a calibration curve for each active was created on the HPLC instrument to be used in this assay. These sampling procedures were repeated over the 5-week timeframe of the static soil study to generate the crop active release curve. The release curves for thiamethoxam for uncoated, PLA coated tablet, PBSA wrapped tablet and other bead types are shown in FIG. 21. Soil release for the fungicide active ingredient azoxystrobin present in PLA coated tablet, uncoated struvite (magnesium ammonium phosphate) tablet and PBSA extruded bead containing corn starch and calcium phosphate are shown in FIG. 22. Similar release profiles for clothianidin containing beads are shown in FIG. 23. In FIG. 22, Prototypes F-B and F-G released a majority to all azoxystrobin payload consistently over 5-week period of the assay. No release of azoxystrobin was observed for prototype F-D over 5 weeks. Similarly, release of Flutriafol in soil is shown in FIG. 20.

### Example 10

### Plant Uptake of Crop Protection Agents Delivered by Polymer Containing Agricultural Compositions

This example demonstrates that crop protection agents (e.g., insecticides and fungicides) delivered by one or more delayed release compositions described herein are taken up by row crop plants over an extended period.

Pots for growth of corn plants were 10 inches in diameter and 7.5 inches deep. Pots were filled with Farfard soil-free potting mix. A 500 ml bottle was placed in the middle of the pot to create a cavity excluding the potting mix. The bottle was carefully placed so that the bottle in each pot was placed in the same position. The potting mix was pressed down gently in order to remove air spaces and additional potting mix was added to bring the level to the brim of the pot. The potting mix in each pot was saturated with water and the excess water was allowed to drain. After this process, the potting mix settled to 1 inch below the brim of the pot. For planting, a 2 inch deep by ¹/₂ inch diameter hole in the potting mix was made. The holes were ¼ inch from the bottle so that the center of the hole was 2 inches from the center of the bottle. Three holes evenly spaced around the 500 ml bottle were made in each pot in this way. Corn seeds (Hybrid 1) were planted, one per hole, and each seed was pressed into the bottom of the hole. Dry potting mix was used to fill in the planting hole and the pots were lightly watered.

The corn plants were grown at 27 C during the day and 25 C at night. The photoperiod was 16 hours with an irradiance of ˜400 μmol/m2/s photosynthetically active radiation at the top of the pot. Irrigation was with dilute Peters 20-20-20 (0.5× strength, equivalent to 0.6 g/liter). Irrigation was increased during the growth of the plants in order to provide sufficient moisture at all times, but not so much that excess liquid seeped out of the bottom of the pots, which could potentially leach crop actives out of the pot.

Plants began to emerge from the potting mix 4 days after sowing. At this time beads for testing were added to each pot. The 500 ml bottle, placed in the middle of each pot during pot preparation, was removed leaving a cavity in the potting mix. This was done carefully to ensure that no potting mix fell back into the hole and to avoid disturbing the young plants. Into each hole was poured 100 ml of a dry soil prepared by mixing equal parts sand and steam-sterilized, sifted Matapeake soil. Matapeake is a low organic carbon soil. Two beads of the same type were placed into the center of the sand/Matapeake mixture and the hole filled to within ¼ inch of the level of the potting mix with more of the sand/Matapeake mixture. Additional Farfard potting mix was used to completely fill the hole so that the surface was even with the rest of the pot. By using the above volumes of potting mix and sand/Matapeake mix the finished pot contained a seed that was 2 inches below the surface and 2 inches to the side of the bead. The beads were contained inside the sand/Matapeake soil mix, 2 inches below the seed level and there was 1 inch of sand/Matapeake soil mix below the seed and 2.5 inches of potting mix between the sand/Matapeake soil mix and the bottom of the pot. On day 11, the plants were thinned to 1 plant per pot.

The beads tested are described in Example 9. Three replicate pots were used for each bead type. Plants were grown for 49 days after sowing (45 days after dosing with the beads). Periodically during the growth of the plants, as noted in the results, leaf samples were collected from the youngest, fully expanded leaf. On day 49, samples from each of the 12 youngest leaves (some of which were still fully enclosed in the inner whorl) were collected. At this stage, there were generally about 15-17 leaves per plant so the oldest 3-5 leaves were not sampled. Leaf samples were collected by taking 5, ˜¼ inch diameter leaf punches from the leaf lamina midway between the leaf tip and base, being careful to avoid the mid-vein. For the youngest 1-2 leaves collected at day 49, the leaves were too small to collect leaf punches and instead a ˜½ inch wide transverse section of the leaf was collected. The fresh weight of leaf samples was recorded and then samples were frozen at −80 C until processing. Active ingredient concentration in the leaves were measured using standard protocols.

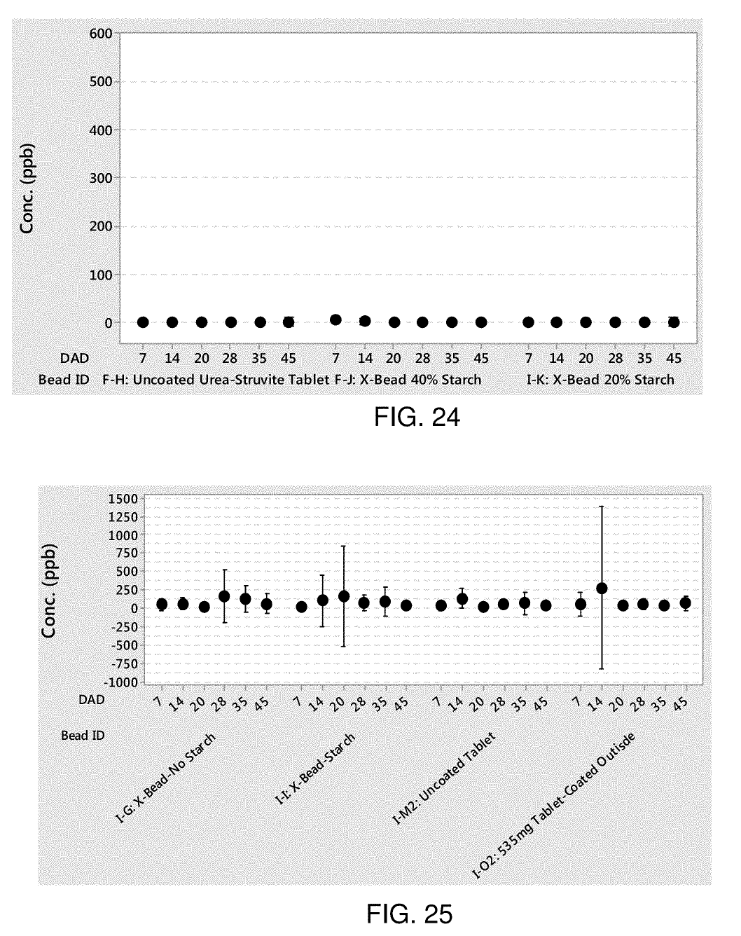

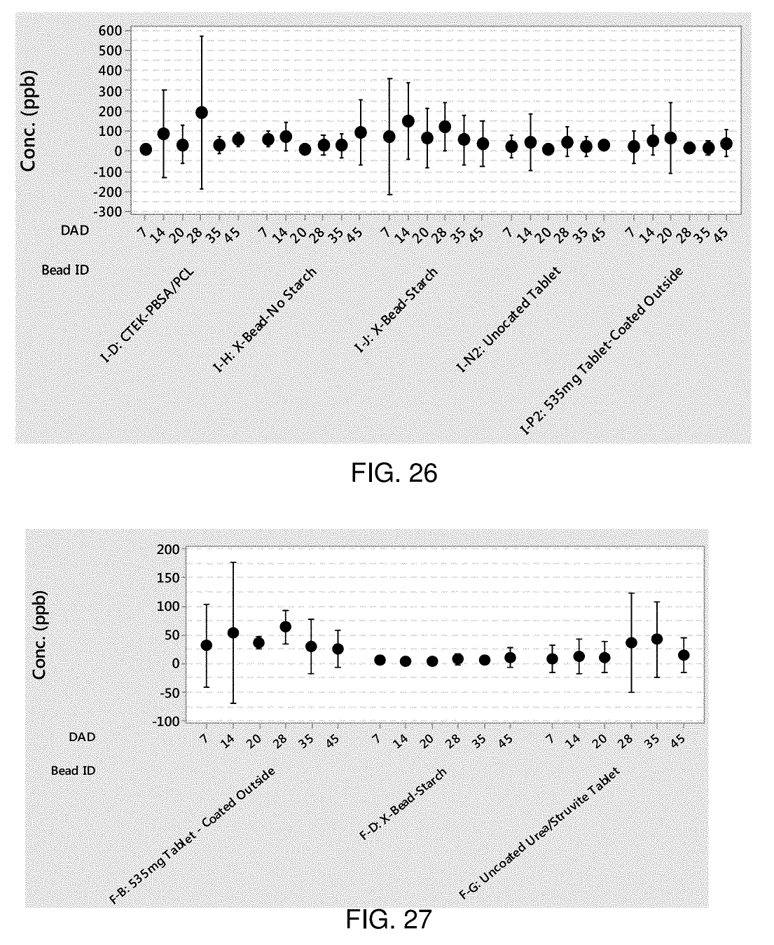

Results from these studies are given in FIG. 24, FIG. 25, FIG. 26 and FIG. 27. As expected no crop active was recovered from the leaves of the negative control plants i.e., those, exposed to various bead formulations lacking the active ingredient. This indicates that pot to pot and sample to sample cross contamination was not an issue in these controlled environment experiments. FIG. 25 shows the Thiamethoxam concentrations in the fully expanded leaves of corn plants collected during the 45 day controlled environment trial. Although there was considerable variation in the amount of Thiamethoxam measured in the leaf samples the data clearly show increased leaf concentrations at the mid to later time points of the experiment, indicating a regulated release of this highly water soluble active ingredient to the plants. Bead I-O2 was equivalent to the Bead I-O described in Example 11, Table 17 which showed high levels of thiamethoxam concentrations in leaf tissues of field grown corn plants 26 DAP and moderate efficacy against corn rootworm damage (Table 17). Despite the high confidence intervals, prototypes I-G and I-I had a consistently higher thiamethoxam uptake at different points of the growth chamber study. Prototype I-I, which is an extruded bead with starch, has previously been shown to release thiamethoxam into soil faster than prototype I-G, which is an extruded bead without starch. This release trend could explain the trends in the plant uptake of thiamethoxam.

FIG. 26 shows the Clothianidin concentrations in the fully expanded leaves of corn plants collected during the 45 day controlled environment trial. Although there was considerable variation in the amount of Clothianidin measured in the leaf samples the data clearly show increased leaf concentrations at the mid to later time points of the experiment, indicating a regulated release of this highly water soluble active ingredient to the plants. Bead I-P2 was equivalent to the Bead I-P described in Example 11, Table 17 which showed high levels of thiamethoxam concentrations in leaf tissues of field grown corn plants 26 DAP and high efficacy against corn rootworm damage (Table 17).

FIG. 27 shows the Azoxystrobin concentrations in the fully expanded leaves of corn plants collected during the 45 day controlled environment trial. Although there was considerable variation in the amount of Azoxystrobin measured in the leaf samples the data show leaf concentrations were higher when the Azoxystrobin was delivered in the presence of a nutrient (either the urea Bead F-B or urea and struvite Bead F-G) c.f., concentrations in plants supplied with Azoxystrobin in a bead lacking the nutrient (Bead F-D). The data indicate a regulated and enhanced uptake of this highly water insoluble active ingredient to the plants.

### Example 11

### Field Experiments Involving Beads Containing Insecticides and Fungicides

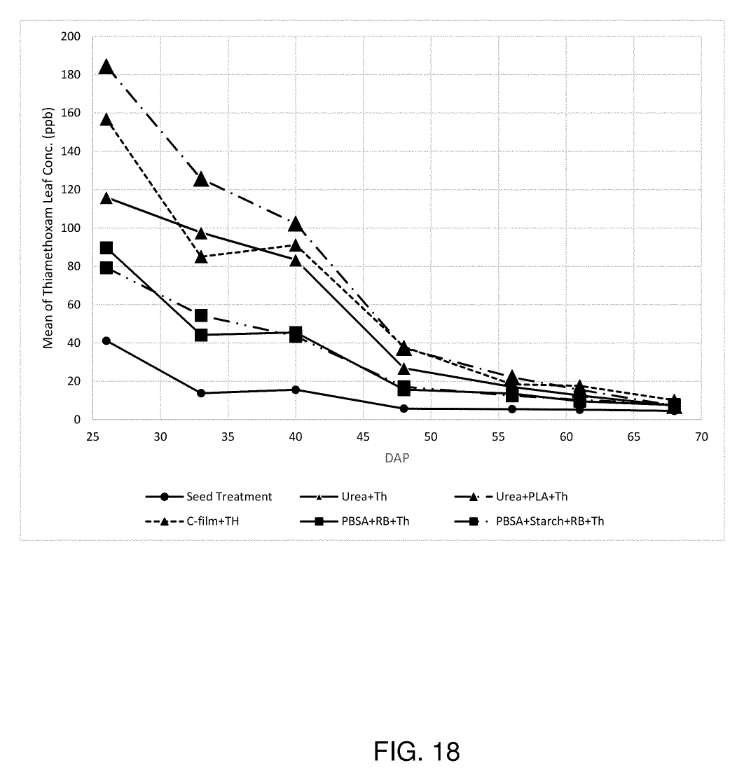

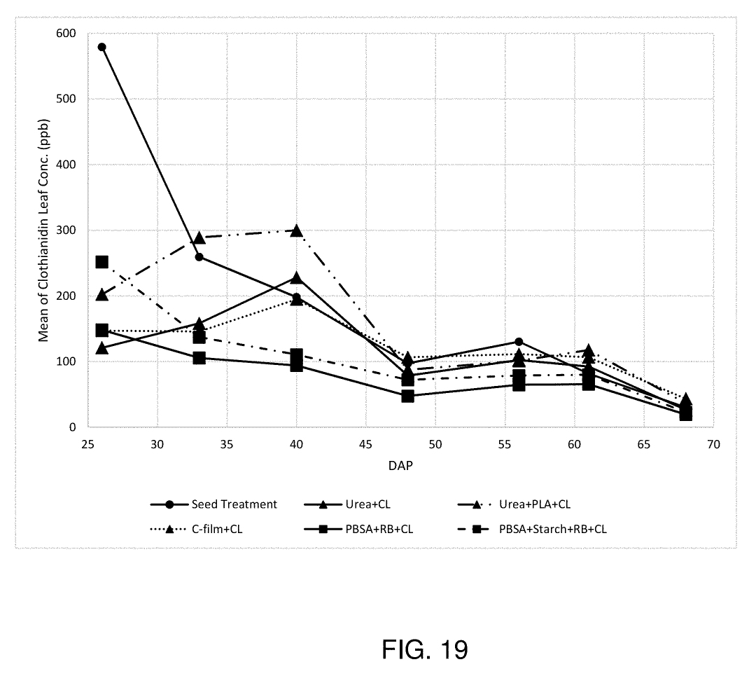

This example demonstrates leaf concentrations, root damage and efficacy scores (where applicable) for a variety of insecticides delivered to corn plants through one or more beads containing those insecticides. Results are shown in FIG. 18 for thiamethoxam and FIG. 19 for clothianidin. Other insecticides that were tested include chlorantraniliprole (denoted as E2Y) and cyantraniliprole (designated as HGW) in the accompanying tables and figures.

TABLE 13
Loading rate for the E2Y and HGW beads are as follows
for those used in Year 1 corn field trial:

| | Target Al |
|---|---|
| Treatment | mg/g of bead |
| HGW 40 PBSA Starch | 10 |
| HGW 60 PBSA Starch | 10 |
| E2Y 25 PBSA Starch | 10 |
| E2Y 50 PBSA Starch | 10 |

TABLE 14
Average damage and average mortality for Year 1 Corn Field Trial.
The beads used are as described in the previous Table.

| | | | Average % Mortality in Lab-Field Bioassay | | | | |
|---|---|---|---|---|---|---|---|
| | | | DAP | | | | |
| TRT | Treatment | RATE (GAA) | 15 | 22 | 30 | 36 | 40 |
| 10 | HGW Seed treatment | 50 | 100 | 61 | 3 | 12.75 | 4.5 |
| 5 | HGW 40 PBSA Starch | 40 | 6.5 | 15.75 | 26.75 | 64.25 | 37.5 |
| 6 | HGW 60 PBSA Starch | 60 | 19 | 63 | 41 | 69 | 61.25 |

| | | | Average of Damage in the Field | | | | |
|---|---|---|---|---|---|---|---|
| | | | DAT | | | | |
| TRT | Treatment | RATE (GAA) | 15 | 22 | 30 | 36 | 40 |
| 10 | HGW Seed treatment | 50 | 7.5 | 57.5 | 30.75 | 23.25 | 22 |
| 5 | HGW 40 PBSA Starch | 40 | 18.75 | 36.5 | 48.5 | 33 | 34.5 |
| 6 | HGW 60 PBSA Starch | 60 | 26.25 | 39.25 | 32.5 | 29.25 | 31.75 |

| | | | Average % Mortality in Lab-Field Bioassay | | | | |
|---|---|---|---|---|---|---|---|
| | | | DAP | | | | |
| TRT | Treatment | RATE (GAA) | 15 | 22 | 30 | 36 | 40 |
| 11 | E2Y Seed treatment | 50 | 94 | 64 | 14.25 | 20.5 | 3.25 |
| 7 | E2Y 25 PBSA Starch | 25 | 3.25 | 22.25 | 34.25 | 8 | 17.25 |
| 8 | E2Y 50 PBSA Starch | 50 | 15.75 | 14.25 | 31.5 | 43.75 | 23.5 |

| | | | Average of Damage in the Field | | | | |
|---|---|---|---|---|---|---|---|
| | | | DAT | | | | |
| TRT | Treatment | RATE (GAA) | 15 | 22 | 30 | 36 | 40 |
| 11 | E2Y Seed treatment | 50 | 3 | 23.75 | 24.5 | 31.75 | 23.75 |
| 7 | E2Y 25 PBSA Starch | 25 | 18.75 | 56.5 | 59 | 39.75 | 42.75 |
| 8 | E2Y 50 PBSA Starch | 50 | 17.75 | 48.75 | 37.25 | 29.25 | 24.5 |

As can be seen from Table 14, mortality in the Lab-Field Bioassay and low Damage in the Field are desirable. For E2Y, by 30 days after treatment the PBSA bead types were providing greater insect mortality in the Lab-Field Bioassay than the seed treatment positive control. For HGW, by 22 days after treatment, majority of the PBSA bead types were providing greater insect mortality in the Lab-Field Bioassay and lower plant damage in the field than the seed treatment positive control.

TABLE 15
Average leaf concentration of E2Y and
HGW delivered through one or more beads

| | Treatment | Field 101 | | | Field 102 | | | |
|---|---|---|---|---|---|---|---|---|
| Treatment | # | 15 | 22 | 30 | 16 | 23 | 30 | 37 |
| HGW 40 PBSA Starch | 5 | 5.2 | 12.1 | 18.8 | 9.4 | 22.3 | 15.4 | 10 |
| HGW 60 PBSA Starch | 6 | 10.3 | 44.4 | 34.1 | 7.9 | 17.7 | 0.6 | 12.9 |
| HGW Seed treatment | 10 | 150 | 24.4 | 6.7 | 54.5 | 15.9 | 0.1 | 0.9 |
| E2Y 25 PBSA Starch | 7 | 0.4 | 4.2 | 3.6 | 1.3 | 4 | 4.8 | 2 |
| E2Y 50 PBSA Starch | 8 | 0.9 | 5.4 | 6.9 | 2.5 | 3.6 | 4.8 | 2.3 |
| E2Y Coated Seed | 11 | 16.1 | 6.1 | 2.3 | 7.9 | 4.4 | 2.3 | 0 |

In both Field 101 and Field 102 the tested PBSA bead types provided similar or greater concentration of the active ingredient in the leaves than the respective seed treatment positive controls by 22 days after planting.

TABLE 16
Active ingredient content for beads used in Year 1 soybean trial

Al Loading (mg Al/g bead)

| Treatment | Target | Actual |
|---|---|---|
| HGW Seed | 0.49 | 0.44 |
| Treeatment | | |
| HGW PBSA No Coat | 10.00 | 7.09 |
| E2Y Seed Treatment | 0.54 | 0.47 |
| E2Y PBSA No Coat | 10.00 | 7.86 |
| Azoxy Liquid 0 d** | 741 | 689 |

**These values are measured in ppm, as it was a suspension in water.

FIG. 24 shows uptake for negative controls as shown in the graph for corn year 2 trials. Points on intervals were based on a 3-plot average. No crop protection agent was used in the control plots. FIG. 25 shows thiamethoxam uptake concentration in corn year 2 trial. 95% confidence interval for the mean values are shown. Individual standard deviations were used to calculate the intervals. DAD—day after delivery of the bead. FIG. 26 shows clothianidin uptake concentration in corn year 2 trial. 95% confidence interval for the mean values are shown. FIG. 27 shows azoxystrobin uptake concentration in corn year 2 trial.

In other greenhouse trials conducted with the beads for E2Y and HGW, the following were observed: Minimal E2Y or HGW soil release was observed for any of the tablet prototypes (4.4 wt % PLA; Al coated on the outside) except for prototype I-Q film-wrapped tablets containing HGW, which illustrated ˜40% release by the conclusion of the 5-week study. In addition, the 8 mm extruded bead prototypes illustrated a minimal delayed release of E2Y into soil over the 5-week assay. No effect of starch content on release profile was observed in this particular trial. Bead size seemed proportional to the release profile with 8 mm beads releasing more than the 2 mm beads (% active released).

### Example 12

### Crop Protection Agents Delivered by Extended Release Beads for Corn Root Worm

This Example demonstrates that crop protection agents delivered by one or more extended release beads target corn root worms in field trials. Field trials were performed at 13 mid-west (IL, IA, SD, MN, IN, NE, WI) sites during the Year 1 season. Three corn hybrids (Hybrid 1 (105); Hybrid 2 (111); Hybrid 3 (112); relative maturity values given in parentheses) were tested at each location. None of the test varieties had transgenic traits to provide endogenous corn rootworm protection, enabling the various pesticide treatments to be evaluated. Experiments were laid out as randomized complete block designs with 15 treatments tested and 4 replicates per treatment. Three positive controls, representing typical commercial methods for the control of corn rootworm, included seed treatments (Thiamethoxam and Clothianidin) and Thiamethoxam seed treatment supplemented with an in-furrow application of 4.4 lb active ingredient Tefluthrin/ac; available from Syngenta Crop Protection LLC). PLA Coated Urea tablets (TRT 4; Table 17) and PBSA/Starch/CaHP04 extruded beads (TRT 5; Table 17) without active ingredients were planted as negative controls; Formulation of the beads used in the treatments are described in Tables 9-11; (Beads, I-P, I-M, I-O, I-N) and 17; (Extruded Beads, I-G, I-H, I-I and I-J). Other bead types used in these trials are shown in Table 17. The desired (target) and actual concentrations of the thiamethoxam and clothianidin actives are given in Tables 10 and 11, Example 9. The treatment beads and seed were planted (between April 23 and May 25 Year 1) using a two pass system with an experimental corn planter. First the beads were planted at a depth of 2¼-2½ inches, the seed were then planted at a depth of 1¾-2 inches in a second pass so that the seed were placed directly above the previously planted beads. Each test plot was 10 feet long. The planting rate for the seed was approximately 37,000 plants per acre and the beads were planted such that there were two beads for every seed (i.e., planting rate of approximately 74,000 beads/acres. Test sites were selected for their history of reliable corn rootworm pressure and had either a trap crop the previous year or were sites in which corn followed corn. Additionally, all test sites were manually infested with either 750 or 1,500 corn rootworm eggs/plant (applied two inches from the plants) at the V2-V4 growth stage. Test plots were evaluated for early stand count and Early Growth Vigor at the V2-V4 stage of growth. Early Runt Count Scores were assessed at the V6 stage of growth. Corn rootworm scores were assessed between the 2^{nd} and 3^{rd} weeks of July, as follows. Test sites were assessed prior to scoring and only those showing low to high nodal root injury scores (>0.5 using the Iowa State 0-3 scoring scale) in the untreated control rows were fully scored. The initial assessment of untreated control plots led to 6 of the possible 13 test sites not being scored; two were assessed as high damage sites, four were assessed as Moderate damage trials and one was assessed as a Low damage test site. Scoring involved pulling 5 consecutive plants from the center of each treatment row and assessing root damage at the crown after washing. The following Iowa State scale was used; 0.0, perfect root, no scarring or feeding damage; 1.0, one node or the equivalent of one node eaten to within 1.5 inches of the stalk or to within 1.5 inches of the soil line for roots starting above ground; 2.0, two nodes eaten to within 1.5 inches of the stalk; 3.0, three nodes eaten to within 1.5 inches of the stalk. On days 26, 33, 40, 48, 56, 61 and 68, after planting, samples were taken for determining the amount of insecticide present in the leaf tissues. Samples were collected from the first fully expanded leaves of the plants as described in Example 10. After harvesting the samples were frozen until analysis. Analysis was performed using standard LC MS/MS methodologies. The results of the leaf analysis and corn rootworm damage assessments are given in the tables below

The bead types used in these trials are shown below and the root damage are shown in tables below.

TABLE 17
Average leaf concentration of thiamethoxam and clothianidin at days after planting.

| | | | Average Thiamethoxam Leaf Conc. (ppb) at_{——}DAP | | | | | | | CRW Score |
|---|---|---|---|---|---|---|---|---|---|---|
| TRT | Bead | Description | 26 | 33 | 40 | 48 | 56 | 61 | 68 | (3-Max damage) |
| 1 | N/A | Thiamethoxam -Positive | 41.2 | 13.8 | 15.6 | 5.8 | 5.5 | 5.2 | 4.6 | 2.4 |
| | | Control - seed treatment | | | | | | | | |
| 4 | I-L | PLA Coated Urea (no Al) | 86.3 | 53.3 | 42.2 | 10.8 | 15.4 | 6.4 | 1.8 | 2.2 |
| | | Negative Control | | | | | | | | |
| 5 | I-K | 70/20/10 | 74.6 | 39.2 | 36.7 | 5.3 | 10.5 | 4.6 | 1.7 | 2.6 |
| | | PBSA/Starch/CaHPO4 Bead | | | | | | | | |
| | | (no Al) Negative Control | | | | | | | | |
| 6 | I-M | Uncoated Pressed | 116 | 97.6 | 83.4 | 26.9 | 17.1 | 12.6 | 7.3 | 1.4 |
| | | Urea/Thiamethoxam Tablet | | | | | | | | |
| 8 | I-O | 2.2% PLA Coated urea - | 184.4 | 125.7 | 102.3 | 37.4 | 22.1 | 15.6 | 7.2 | 1.5 |
| | | Thiamethoxam on outside | | | | | | | | |
| 10 | I-C | 4mil PBSA Wrapped | 156.8 | 85 | 91.1 | 38 | 18.5 | 17.6 | 10.1 | 1.4 |
| | | Urea/Thiamethoxam Tablet | | | | | | | | |
| 12 | I-G | 90/10 PBSA Bead (no | 89.7 | 44.2 | 45.5 | 15.7 | 13.6 | 9.6 | 7.6 | 2.1 |
| | | starch) - Thiamethoxam | | | | | | | | |
| 14 | I-I | 70/20/10 PBSA/Starch Bead - | 79.3 | 54.4 | 43.5 | 17.2 | 12.5 | 10.3 | 8 | 1.5 |
| | | Thiamethoxam | | | | | | | | |

| | | | Average Clothianidin Leaf Conc. (ppb) at_{——}DAP | | | | | | | CRW |
|---|---|---|---|---|---|---|---|---|---|---|
| TRT | Bead | Description | 26 | 33 | 40 | 48 | 56 | 61 | 68 | Score |
| 2 | N/A | Clothianidin Positive | 579 | 259.4 | 198.3 | 97.3 | 130.4 | 82 | 30.2 | 1.8 |
| | | Control - seed treatment | | | | | | | | |
| 4 | I-L | PLA Coated Urea (no Al) | 7.2 | 9.1 | 6.4 | 3.9 | 5.1 | 4.5 | 2.1 | 2.2 |
| | | Negative Control | | | | | | | | |
| 5 | I-K | 70/20/10 PBSA/Starch Bead | 5.8 | 12.4 | 5.8 | 2.3 | 4.1 | 3.6 | 1.6 | 2.6 |
| | | (no Al) Negative Control | | | | | | | | |
| 7 | I-N | Uncoated Pressed | 121.2 | 158.4 | 228.3 | 78.7 | 102.5 | 92.5 | 26.4 | 1.4 |
| | | Urea/Clothianidin Tablet | | | | | | | | |
| 9 | I-P | 2.2% PLA Coated urea - | 202.5 | 289 | 300 | 87.6 | 101.3 | 117.7 | 36.6 | 1.1 |
| | | Clothianidin on outside | | | | | | | | |
| 11 | I-D | 4mil PBSA Wrapped | 147.4 | 146 | 195 | 106.7 | 111.5 | 106.8 | 43.7 | 1.7 |
| | | Urea/Clothianidin Tablet | | | | | | | | |
| 13 | I-H | 90/10 PBSA Bead (no | 148.4 | 105.7 | 94.3 | 47.8 | 64.8 | 65.8 | 19.6 | 2.2 |
| | | starch) - Clothianidin | | | | | | | | |
| 15 | I-J | 70/20/10 PBSA/Starch Bead - | 251.8 | 137.4 | 110.7 | 72.4 | 79 | 80 | 23 | 1.9 |
| | | Clothianidin | | | | | | | | |

Overall, the tested bead types provided greater concentrations of thiamethoxam in the leaves than the seed treatment positive control. For example, by 33 days after planting, some of the bead types were providing greater concentrations of clothianidin in the leaves than the seed treatment positive control and by 50 days after planting many of the tested bead types provided similar or greater concentrations of clothianidin in the leaves than the seed treatment positive control. For thiamethoxam all but one of the bead types was given an average score lower than the seed treatment positive control and half of the clothianidin bead types received an average score similar to or lower than the seed treatment positive control.

In all trials the Force 3G® positive control provided the greatest level of corn rootworm protection, with average nodal injury scores of 0.4 (range 0.1 to 0.71 across sites with low, moderate and high corn rootworm pressure, respectively).

AI (either Thiamethoxam or Clothianidin) mixed with Urea tablets (beads I-M and I-N) and the AI on the outside of tablet (beads I-O and I-P) and then the film-wrapped Ctek beads (beads I-C and I-D) performed similarly or better than the Clothianidin (1250 rate) applied as seed treatment for positive controls. Clothianidin had numerically better nodal injury scores and consistency ratings than thiamethoxam.

Under the highest insect pressure, the Urea-PLA-CI treatment (Bead I-P) performed better than the Clothianidin-1250 seed treatment positive controls. Urea tablets (beads I-C, I-D, I-M, I-N, I-O and I-P) delivered higher insecticide leaf concentrations versus the PBSA beads (beads I-G, I-I, I-H and I-J) and these higher concentrations were correlated with better root protection.

High leaf concentrations of AI at 40 Days after planting were highly correlated with root protection (R2 for Thiamethoxam=0.6446; R2 for Clothianidin=0.899). The Urea-PLA-CI treatment (Bead I-P) had higher leaf clothianidin levels (300 ppb) than the Clothianidin-1250 seed treatment (198 ppb) positive controls and a higher degree of protection from corn rootworm (CRW score of 1.1 vs 1.8, respectively). The leaf concentrations of Thiamethoxam and Clothianidin measured throughout the field trial have been plotted in FIG. 18 and FIG. 19, respectively. All extended release beads tested led to higher leaf concentrations of Thiamethoxam than was observed in the positive control (seed) treatment. In the case of Clothianidin (FIG. 19), the highest leaf concentrations were observed for the seed treatment positive control 26 days after planting and then dropped off sharply. The influence of the beads, particularly I-P, (Urea+PLA+CL) on extending the release of Clothianidin can clearly be observed (FIG. 19). Delayed thiamethoxam release observed for prototypes I-I and I-G in FIG. 21, in which the pesticide is incorporated into the polymer in the form of an extruded bead. The addition of starch to these extruded bead prototypes increased release of the payload overtime as seen with prototype I-I. About 100% instantaneous release of thiamethoxam payload was exhibited by prototypes I-M, I-C and I-O. Decline in release of pesticide illustrated by these prototypes following week 1.

Taken together with the release profiles of the crop protection agents in in-vitro soil release studies (Example 9; FIG. 21 and FIG. 23), the extended release of the crop protection agents afforded by the beads described herein provides effective control corn rootworm in the field, including under high insect pressure. Each data point represents the % AI that was released from those beads/tablets that were measured at a particular time. Because of the bead to bead variability within the triplicates, the average value can be higher than 100% since the calculations were done based upon target Al amount.

### Example 13

### Controlled Environment/Growth Chamber Studies: Plant Uptake-Leaf Concentration (ppb) of E2Y and HGW

This example demonstrates the various uptake concentrations of HGW (cyantraniliprole) and E2Y (chlorantraniliprole) containing tablets in corn and soybean. The bead/tablet description is shown below in Table 18.

Controlled environment experiments with corn and soybean were set up and performed as described in Example 10, with the following exceptions, except that a different soybean variety was used. After the seedlings had emerged and the first unifoliate leaves had formed the weakest seedling in each pot was cut off at the soil surface, leaving two plants per pot. Chamber conditions were 27° C. daytime with a night time temperature of 20° C.; the photoperiod was 14 hours. Leaf punches (avoiding major veins) were collected as described in Example 10. The five punched samples were taken from one leaflet of the first fully-expanded trifoliate leaf.

TABLE 18
Brief description of beads used in the controlled environment/growth chamber studies.

| Active | Bead Short Name | Bead Description |
|---|---|---|
| E2Y | X-bead: 2 mm-20% | 60 wt % PBSA/10 wt % Calcium Phosphate/20 wt % Starch, |
| | Starch | 2 mm E2Y Beads |
| E2Y | X-bead: 8 mm-20% | 69.7 wt % PBSA/10 wt % Calcium Phosphate/20 wt % Starch, |
| | Starch | 8 mm E2Y Beads |
| E2Y | X-bead: 2 mm-40% | 40 wt % PBSA/10 wt % Calcium Phosphate/40 wt % Starch, |
| | Starch | 2 mm E2Y Beads |
| E2Y | X-bead: 8 mm-40% | 49.7 wt % PBSA/10 wt % Calcium Phosphate/40 wt % Starch, |
| | Starch | 8 mm E2Y Beads |
| E2Y | 535 mg PLA Tablet | E2Y formulation pressed with urea 0.16 wt %, ~4.4 wt % PLA |
| | Al Inside | |
| E2Y | 535 mg PLA Tablet | E2Y formulation coated on the outside 0.16 wt %, 4.4 wt % |
| | Al Outside | |
| E2Y | Ctek | E2Y, C-film wrapped Bead |
| HGW | X-bead: 2 mm-20% | 60 wt % PBSA/10 wt % Calcium Phosphate/20 wt % Starch, |
| | Starch | 2 mm HGW Beads |
| HGW | X-bead: 8 mm-20% | 69.4 wt % PBSA/10 wt % Calcium Phosphate/20 wt % Starch, |
| | Starch | 8 mm HGW Beads |
| HGW | X-bead: 2 mm-40% | 40 wt % PBSA/10 wt % Calcium Phosphate/40 wt % Starch, |
| | Starch | 2 mm HGW Beads |
| HGW | X-bead: 8 mm-40% | 49.4 wt % PBSA/10 wt % Calcium Phosphate/40 wt % Starch, |
| | Starch | 8 mm HGW Beads |
| HGW | 535 mg PLA Tablet | HGW formulation pressed with urea 0.32 wt %, ~4.4 wt % |
| | Al Inside | PLA |
| HGW | 535 mg PLA Tablet | HGW formulation coated on the outside 0.32 wt %, 4.5 wt % |
| | Al Outside | |
| HGW | Ctek | HGW, C-film wrapped Bead |

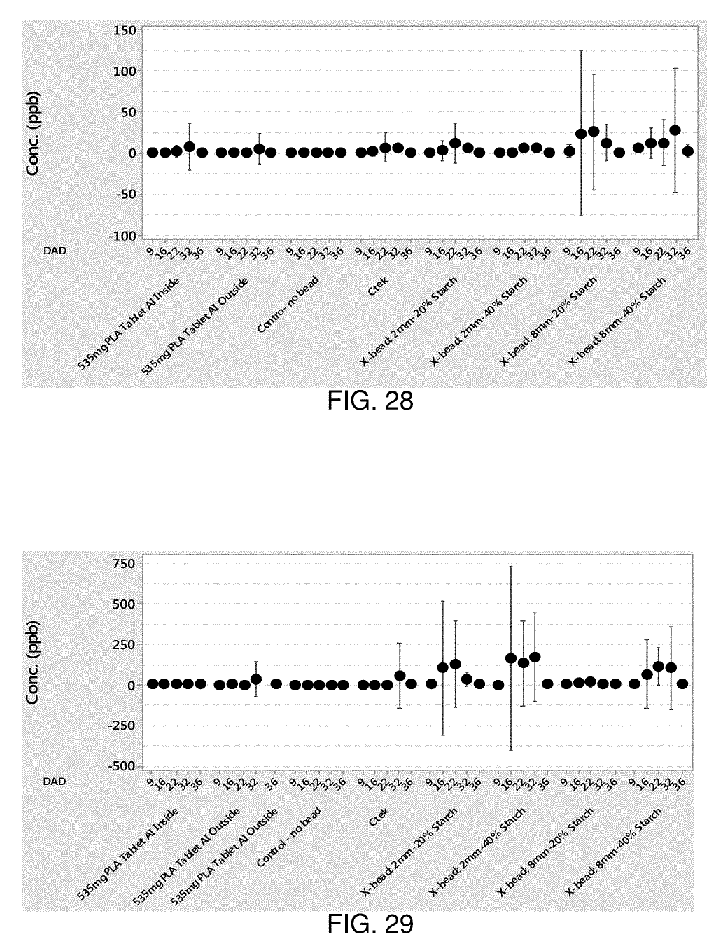

FIG. 28 shows leaf E2Y (chlorantraniliprole) concentration measured in corn leaves collected during a 36-day treatment period. The bars indicate the 95% confidence interval for the mean values. Individual standard deviations were used to calculate the confidence intervals. DAD—day after delivery of the bead. Although there was considerable variations in the amount of E2Y measured in the leaf samples the data demonstrated increased leaf concentrations at later time points, indicating a controlled release of the active ingredient to the plants. LD-50 for E2Y for numerous important lepidopteran pests of corn (including Army Worm; Spodoptera frugiperda) may fall in the 15-20 ppb range. All the PLA coated tablets, 8 mm-20% Starch X-beads, and Ctek wrapped tablets provide little to no E2Y uptake in corn. 8 mm-X-beads demonstrated the highest E2Y uptake among the tested beads in this trial.

FIG. 29 shows leaf HGW (cyantraniliprole) concentration measured in corn leaves collected during a 36-day treatment period. The bars indicate the 95% confidence interval for the mean values are shown. Individual standard deviations were used to calculate the intervals. DAD—day after delivery of the bead. Although there was considerable variation in the amount of HGW measured in the leaf samples, the data show increased leaf concentrations at later time points, indicating a controlled release of the active ingredient to the plants. Previous studies have shown that the LD-50 for HGW for numerous important lepidopteran pests of corn (including Army Worm; Spodoptera frugiperda) fall in the 50-60 ppb range. All the PLA coated tablets, 8 mm-20% Starch X-beads, and Ctek-film wrapped tablets provide little to no HGW uptake in corn. 2 mm-X-beads and 8 mm-40% Starch X-beads illustrated the highest HGW uptake in corn among the tested beads in this trial.

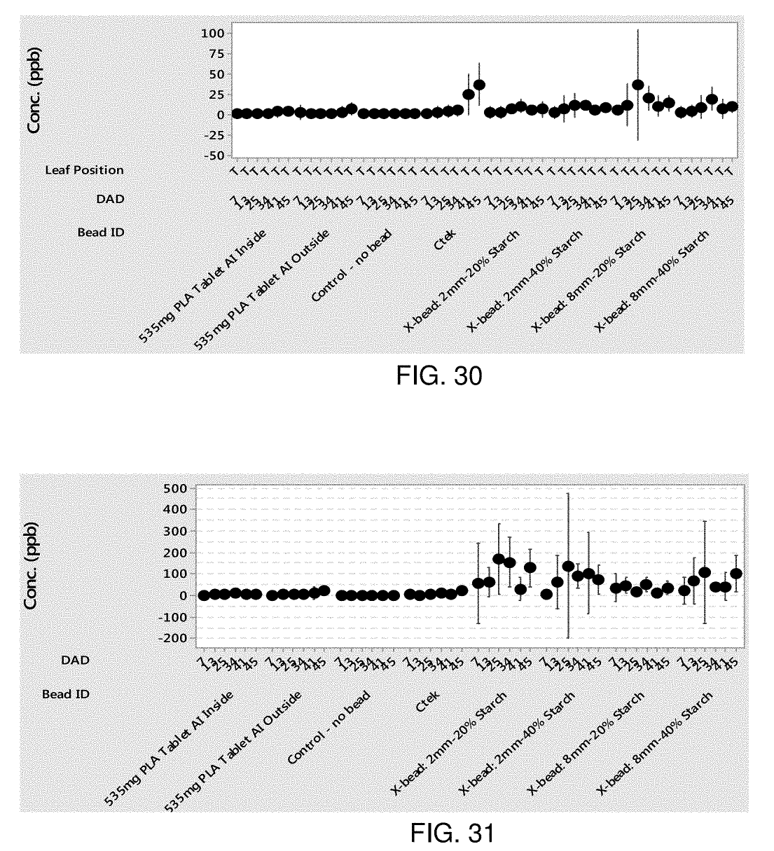

FIG. 30 shows leaf E2Y (chlorantraniliprole) measured in soybean leaves collected during a 45 treatment period. The bars indicate the 95% confidence interval for the mean values. Individual standard deviations were used to calculate the confidence intervals. DAD—day after delivery of the bead. Although there was considerable variation in the amount of E2Y measured in the leaf samples the data show increased leaf concentrations at later time points, indicating a controlled release of the active ingredient to the plants. Previous studies have shown that the LD-50 for E2Y for numerous important lepidopteran pests of soy (including Army Worm; Spodoptera frugiperda and Velvet Bean Caterpillar (Anticarsia gemmatalis)) fall in the 15-20 ppb range. In FIG. 30, the PLA coated tablets and 2 mm X-beads do not provide an increase in E2Y uptake in soybean compared to the Ctek-film wrapped and extruded beads (denoted by X). 8 mm X-beads seemed to show consistently higher E2Y uptake in soybean through the study. The Ctek prototypes illustrated the highest E2Y uptake by the end of the growth chamber study.

FIG. 31 shows leaf HGW (cyantraniliprole) measured in soybean leaves collected during a 45 treatment period. The bars indicate the 95% confidence interval for the mean values. Individual standard deviations were used to calculate the confidence intervals. DAD—day after delivery of the bead. Although there was considerable variation in the amount of HGW measured in the leaf samples the data clearly show increased leaf concentrations at later time points, indicating a controlled release of the active ingredient to the plants. LD-50 for HGW for numerous important lepidopteran pests of soy (including Army Worm; Spodoptera frugiperda and Velvet Bean Caterpillar (Anticarsia gemmatalis)) may fall in the 50-60 ppb range. In FIG. 31, the PLA coated tablets, 8 mm-20% Starch X-beads, and Ctek-film wrapped tablets do not provide an increase in HGW uptake in soybean, compared to the extruded beads (designated by X). 2 mm X-beads and 8 mm-40% Starch X-beads demonstrated the highest HGW uptake in soybean among the beads tested in this trial.

### Example 14

### Water Release Profiles of Spray-Coated Urea Fertilizer

This example demonstrates the various release profiles of spray-coated urea tablets having different shape/size and coating thicknesses in water at two different physiologically relevant temperature conditions.

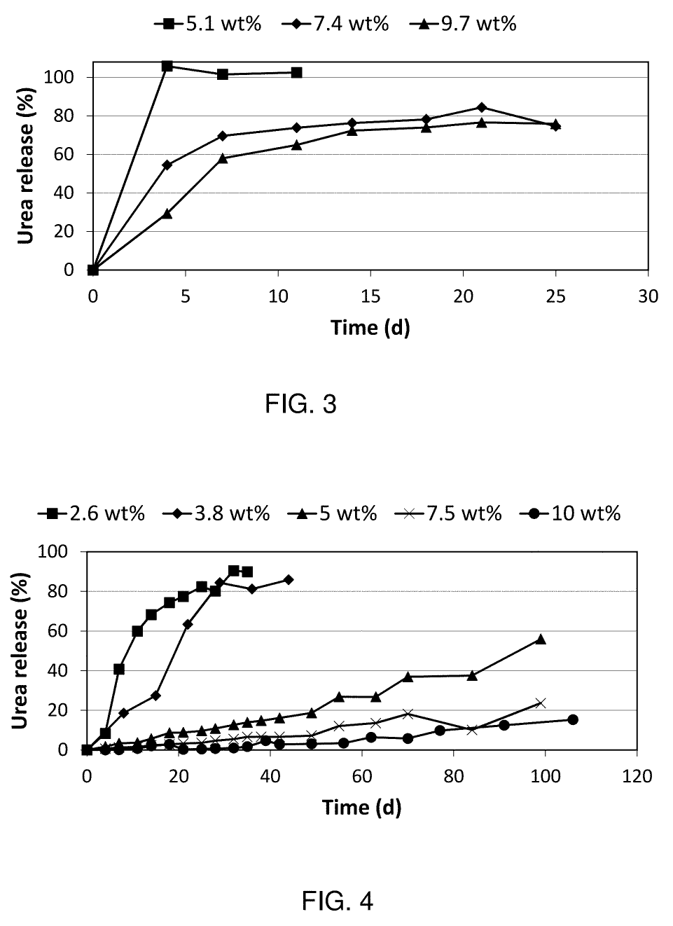

As shown in FIG. 3, the cumulative release of urea into water at 22° C. from PLA-coated urea prills (3-5 mm) which are coated at three different ratios (5.1, 7.4 and 9.7% based on the mass ratio of PLA to urea) were determined. The samples were prepared by a spraying coating process using 10 wt % PLA solution in MEK and commercial urea prills of 3-5 mm diameter. Two grams of each sample were used in the test. The test was conducted in triplicate. Further, the cumulative release of urea into water at 22° C. from PLA-coated urea tablets (1600 mg), coated at five different ratios (2.6, 3.8, 5.0, 7.5 and 10% based on the mass ratio of PLA to urea), were determined and results are shown in FIG. 4. The samples are prepared by a spraying coating process using 10 wt % PLA solution in MEK and tablets that are 13 mm in diameter and of standard shape and contain 1600 mg urea per tablet. Three tablets of each sample were used in the test. The test was conducted in triplicate. FIG. 5 shows cumulative release of urea into water at 35° C. from PLA-coated urea tablets which are coated at three different ratios (2.6, 3.8, and 5.0% based on the mass ratio of PLA to urea). The samples were prepared by a spraying coating process using 10 wt % PLA solution in MEK and tablets that were 13 mm in diameter and of standard shape and contain 1600 mg urea per tablet. Three tablets of each sample were used in the test. The test was conducted in triplicate. Similarly, cumulative release of urea into water at 22° C. from PLA-coated urea tablets that are 11.1 mm in diameter and of different shapes (standard, deep, extra deep and modified ball) were determined and the results are shown in FIG. 6. Each tablet contained 800-840 mg urea, depending on the shape: standard 800 mg, deep 840 mg, ex-deep 814 mg and modified ball 836 mg. The tablets were coated at two different ratios (3.3 and 5.5% based on the mass ratio of PLA to urea). Three tablets of each sample were used in the test and conducted in triplicate.

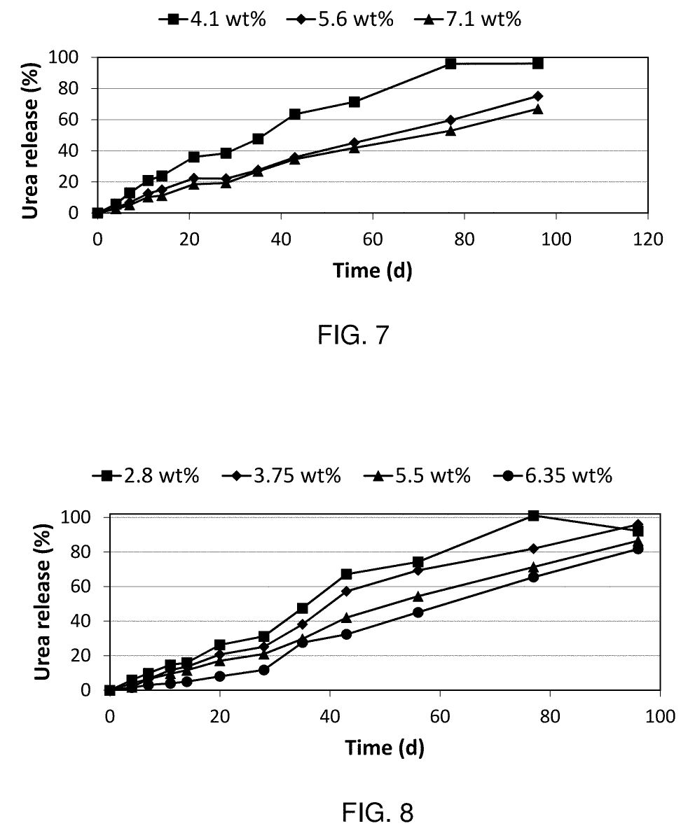

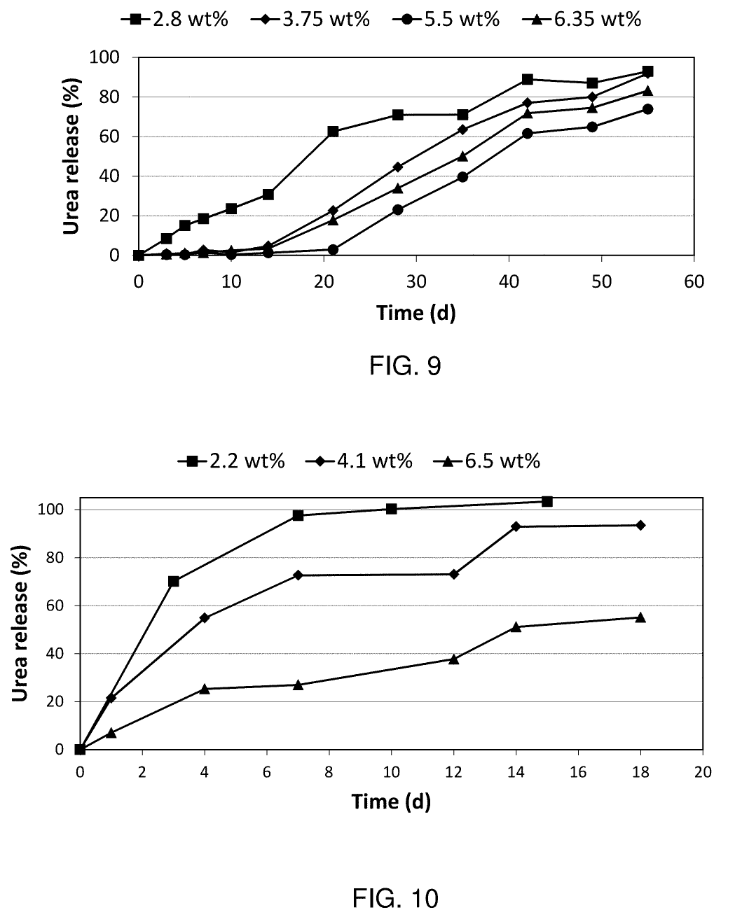

FIG. 7 shows cumulative release of 9.5 mm PLA-coated urea tablets into water at 22° C. coated at three different ratios (4.1, 5.6 and 7.1% based on the mass ratio of PLA to urea). The samples were prepared by a spraying coating process using 10 wt % PLA solution in MEK and tablets that are 9.5 mm in diameter and of standard shape and contain 535 mg urea per tablet. Three tablets of each sample were used in the test in triplicate. The cumulative release of urea into water at 22° C. from PLA-coated urea tablets which are coated at four different ratios (2.8, 3.75, 5.5 and 6.35% based on the mass ratio of PLA to urea) were determined and the results are shown in FIG. 8. The samples were prepared by a spraying coating process using 10 wt % PLA solution in MEK and tablets that are 9.5 mm in diameter and of extra deep shape and contain 535 mg urea per tablet. The samples in this test were prepared in 1 kg pilot batches. Three tablets of each sample were used in the test in triplicate. In addition, the cumulative release of 9-mm PLA-coated urea tablets into water at 35° C. at four different coating ratios (2.8, 3.75, 5.5 and 6.35% based on the mass ratio of PLA to urea), were also determined. The samples were prepared by a spraying coating process using 10 wt % PLA solution in MEK and tablets that are 9.5 mm in diameter and of extra deep shape and contain 535 mg urea per tablet. The samples in this test were prepared in 1 kg pilot batches. Three tablets of each sample were used in the test in triplicate.

FIG. 10 shows the cumulative release of urea into water at 22° C. from PLA-coated urea tablets which are coated at three different ratios (2.2, 4.1 and 6.5% based on the mass ratio of PLA to urea). The samples are prepared by a spraying coating process using 10 wt % PLA solution in MEK and tablets that are 9 mm in diameter and of extra deep shape and contain 535 mg urea per tablet. The samples in this test were prepared in 50 kg production batches. Three tablets of each sample were used in the test in triplicate.

The water release experiments have demonstrated a strong correlation of release rate to the coating ratio of the spray-coated tablets—the higher the coating ratio, the slower the release of N into water. This correlation (or trend) holds at both 22° C. and 35° C., although the releases are accelerated at elevated temperatures. The release rate is affected by the size of the urea core. At the comparable coating ratio, larger urea tablets show slower release rates than the urea granules. Among the urea tablets with different sizes, 1600 mg tablets release more slowly than the smaller 800 mg or 535 mg tablets. The shape of tablet also has an impact on the release rate, particularly with tablets of similar sizes. As the shape of the tablet goes towards spherical, the release of the tablets decreases given the comparable coating ratio. Processing conditions during production of coated tablets also impact the release rates. For example, coated urea tablets that was produced in a pilot batch on 1 kg scale using a small coater release slower than the ones that were produced with a comparable coating ratio but in a production batch on 50 kg scale using a large coater. The variation could be due to slightly different coating conditions, e.g., distance of the spraying nozzle to the coating bed.

### Example 15

### Release Profiles of Film-Wrapped Urea Containing Agricultural Compositions

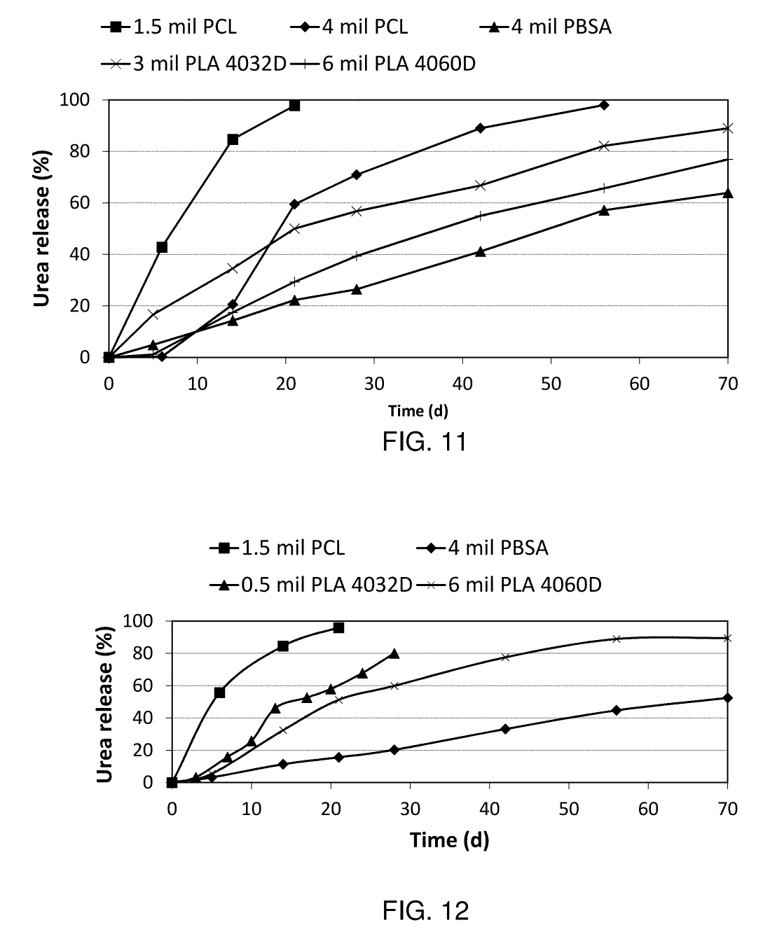

FIG. 11 shows the cumulative release of urea into water at 22° C. from film-wrapped urea tablets of 9.5 mm diameter. The samples are prepared by a proprietary film coating process using different polymer films and tablets that are 9.5 mm in diameter and of standard shape and contain 535 mg urea per tablet. Three tablets of each sample were used in the test. The test was conducted in triplicate.

FIG. 12 shows cumulative release of urea into water at 22° C. from film-wrapped urea tablets. The samples are prepared by a proprietary film coating process using different polymer films and tablets that are 9.5 mm in diameter and of extra deep shape and contain 535 mg urea per tablet. Three tablets of each sample were used in the test. The test was conducted in triplicate. Controlled release in water has been observed with film-wrapped urea fertilizers. The release rate is affected by both the film thickness and the film material. Films with lower permeation rate, which can be resulted from being thicker or using less permeable material or both, give slower release.

### Example 16

### Release Profiles of Film-Wrapped Urea Containing Agricultural Compositions in Soil

This example demonstrates the release profiles of PLA-coated urea beads in soil. A known amount of sample is buried near the center of a 4″×4″×4″ plastic pot containing soil. The pot is placed under a dripping head which provides water to the pot at 150 mL/day. The effluent is collected at the bottom of the pot. The pot is placed in a controlled environment chamber with an average daily temperature of 25° C. At predetermined times, the collected effluent is measured for concentrations of urea, ammonium and nitrate. Urea concentration is determined by a colorimetric assay using a commercially available kit. Ammonium and nitrate concentrations are determined by ammonium and nitrate selective electrodes (Beckman), respectively. Total nitrogen release is calculated based on the sum of the amount nitrogen in urea, ammonium and nitrate.

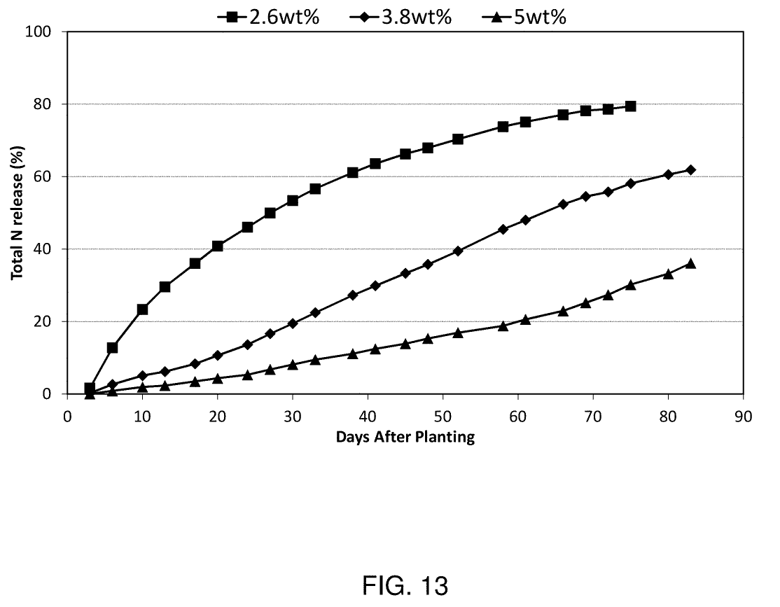

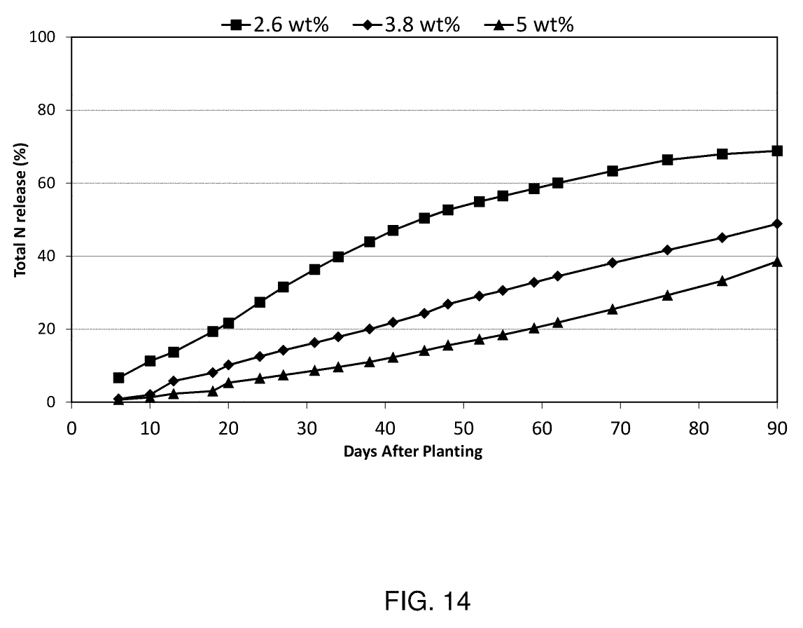

FIG. 13 shows cumulative release of total nitrogen into Fruitland soil at 25° C. from PLA-coated urea tablets which are coated at three different ratios (2.6, 3.8 and 5.0% based on the mass ratio of PLA to urea). The samples are prepared by a spraying coating process using 10 wt % PLA solution in MEK and tablets that are 9.5 mm in diameter and of extra deep shape and contain 535 mg urea per tablet. One tablet of each sample was used in the test. The test was conducted in four replicates. The 2.6% coated tablets had the fastest release with about 80% released before 80 days after planting, while the 5% coated tablets had only released about 35% cumulative by day 80. The 3.8% coated tablets had released about 60% N by day 80. In addition, about 45% to about 60% cumulative N was released by the 3.8% coated tablets between day 60 and 80 after planting, which corresponds to the time, a standard maize hybrid displays flowering. Similar trend lines were observed for the PLA-coated 1600 mg tablets in FIG. 14.

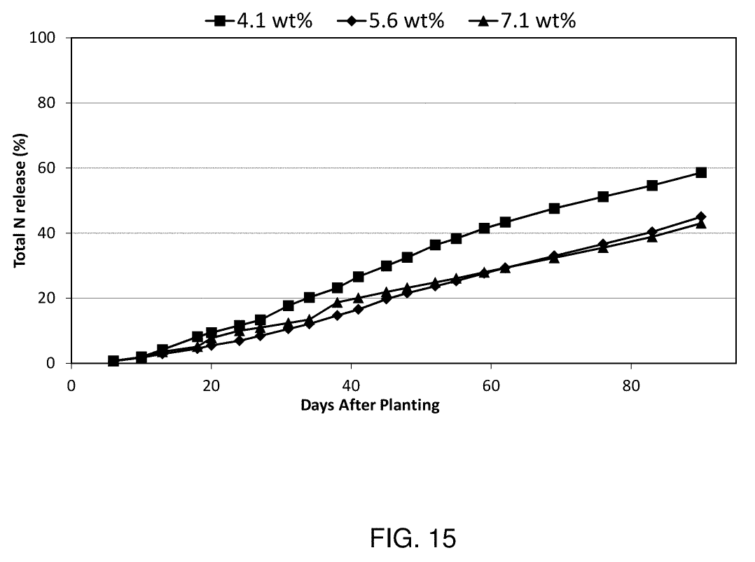

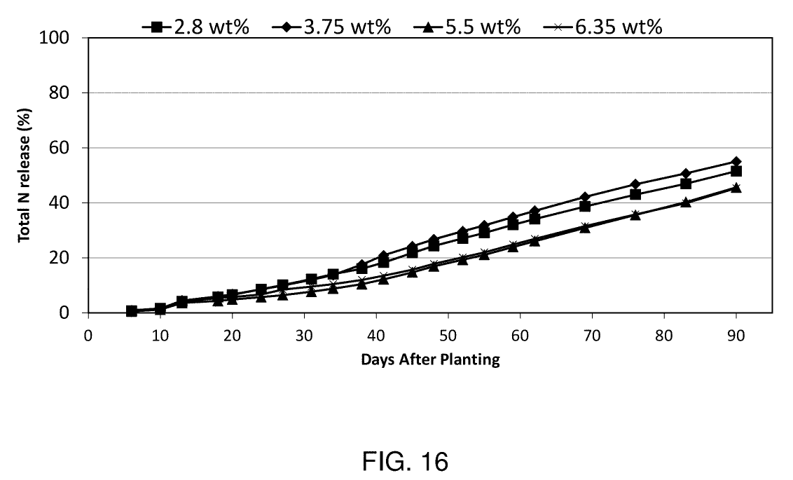

FIG. 14 shows cumulative release of total nitrogen into Sciota soil at 25° C. from PLA-coated urea tablets which are coated at three different ratios (2.6, 3.8 and 5.0% based on the mass ratio of PLA to urea). The samples are prepared by a spraying coating process using 10 wt % PLA solution in MEK and tablets that are 9.5 mm in diameter and of extra deep shape and contain 535 mg urea per tablet. FIG. 15 shows cumulative release of total nitrogen into Sciota soil at 25° C. from PLA-coated urea tablets which are coated at three different ratios (4.1, 5.6 and 7.1% based on the mass ratio of PLA to urea). The samples are prepared by a spraying coating process using 10 wt % PLA solution in MEK and tablets that are 9.5 mm in diameter and of standard shape and contain 535 mg urea per tablet. The samples in this test were prepared in 1 kg pilot batches. As shown in FIG. 15, the thicker coated tablets (i.e., 5.6% and 7.1%) exhibit a slower release and they release only about 45-50% cumulative N, 90 days after planting compared to about 80% for the thin coated beads of 2.6% and 3.8% in FIG. 13. Similar slower release trend lines were observed for the 535 mg Ex-Deep urea tablets in FIG. 16.

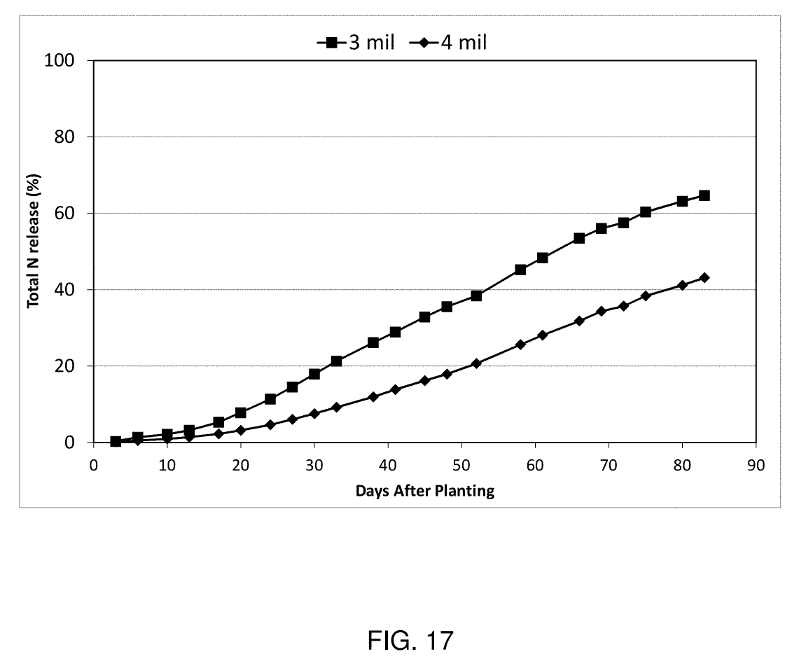

FIG. 16 shows cumulative release of total nitrogen into Sciota soil at 25° C. from PLA-coated urea tablets which are coated at four different ratios (2.8, 3.75, 5.5 and 6.35% based on the mass ratio of PLA to urea). The samples are prepared by a spraying coating process using 10 wt % PLA solution in MEK and tablets that are 9.5 mm in diameter and of extra deep shape and contain 535 mg urea per tablet. FIG. 17 shows cumulative release of total nitrogen into Fruitland soil at 25° C. from PLA shrink-wrapped ammonium sulfate tablets. The samples are prepared by a shrink wrapping process using PLA films of different thicknesses and tablets that are 13 mm in diameter and of standard shape and contain 1900 mg ammonium sulfate per tablet. One tablet of each sample was used in the test. The test was conducted in four replicates.

Controlled release from various sprayed-coated and shrink-wrapped urea tablets has been observed in soil, albeit much slower release rate compared to that of the same product in water. The dependencies of the release rate on the coating ratio and on the size and shape of tablet are also evident in the soil release. Compared to coating thickness and shape/size of the tablet, relative variation due to soil type in the tested locations, however, was only minimal.

### Example 17

### Melt Extrusion Process for Making Extended Release Agricultural Compositions

Generally, extrusion involved a process of forcing raw materials at elevated controlled temperature and pressure through a heated barrel into an article of manufacture that is of uniform shape and density. Hot-melt extrusion (HME) is used to manufacture sustained release polymer-based pellets of various sizes and shapes. HME generally involves compaction, followed by conversion of blends from a powder or a granular mix into an article of uniform shape. During the HME process, polymers are melted and formed into products of different shapes and sizes such as tablets by forcing polymer components and active ingredients (e.g., urea, ammonium sulphate, crop protection agents) including any additives or plasticizers through an orifice or die under controlled temperature, pressure, feeding rate, and screw speed. One desirable aspect of HME is to disperse active ingredients in a matrix at the molecular level, thus forming a uniform dispersed sustained release polymer mixed with agricultural compositions thereby controlling biodegradability, bioavailability, dissolution or release rates of crop protection agents such as pesticides and herbicides.

### Example 18

### Melt Extrusion Process for Making Polymer Encapsulated Crop Protection Active Ingredients Containing Delayed-Release Compositions

This method describes a process to produce plantable beads or pellets containing crop protection agents with delayed release profile. Delayed release provides season-long protection against pest pressure; encapsulated compositions remain stable and active without premature degradation due to moisture/hydrolysis, microbial action; potential increased bioavailability and uptake; and improved efficacy and reduction in the net amount of crop protection agents/active ingredients that are needed to offer the same or similar level of protection, such as for example, through foliar sprays or in-season side-dress application. A suitable delivery system is to encapsulate the crop protection agents in a biodegradable polymer matrix during and/or after delivery of the active ingredients. A system described herein in this Example, includes a biodegradable matrix such as poly-butylene succinate (PBSA), a swellable and/or leachable second phase such as (corn) starch. Starch is included to help create pathways for water. In this Example, 8 mm beads as well as 2 mm beads were produced that contained Thiamethoxam and/or flutriafol as the crop protection active ingredients.

The mixing of all ingredients was performed using co-rotating, intermeshing, twin-screw extruder technology. Commercial equipment was used. The corn starch and crop protection agent were bag shaken by hand for 60 to 90 seconds. Material exiting the extruder is directed through a die, which is attached to the last barrel. The die geometry included 2 mm or single-hole 8 mm diameter. Pressure generated by the extruder forces the material to flow through the die and form strands. These strands fall into a water trough to cool down and solidify the material and subsequently cut into pellets. Pellet geometry can be controlled using the pelletizer knife speed and draw speed. All barrel temperatures were set at 120 degrees Centigrade except Barrel 1 which is kept at room temperature to avoid sticking and feeding issues. The screw speed was varied between 300-500 RPM depending on feed rates. Typical total feed rates were 5 lbs/hr for the 2 mm beads and 12 lb/hr for the 8 mm beads. The melt temperature of the material exiting the die is kept below 135 degrees Centigrade to avoid thermal degradation of the crop protection agents. The ingredients list and recipe are shown in Table 19.

TABLE 19
Extruded materials for the hot-melt extrusion process

| | | | Calcium | |
|---|---|---|---|---|
| | | Corn | phosphate | Crop |
| | PBSA | Starch | dibasic | Protection |
| Experiment # | (wt %) | (wt %) | (wt %) | Active (wt %) |
| 1 | 60 | 20 | 10 | 10 |
| 2 | 40 | 40 | 10 | 10 |
| 3 | 49.77 | 40 | 10 | 0.23 |
| 4 | 60 | 20 | 10 | 10 |
| 5 | 40 | 40 | 10 | 10 |
| 6 | 69.63 | 20 | 10 | 0.37 |
| 7 | 70 | 20 | 10 | 0 |

1. An agricultural composition comprising:
a) a fertilizer core comprising from about 0.1 to 0.8 grams of nitrogen; and
b) a polymer layer surrounding the fertilizer core;
wherein the polymer layer has a water permeability of about 1 to about 2000 g/m2/day at 25 degrees Celsius and wherein the fertilizer composition when placed in a field delivers an effective amount of nitrogen during late vegetative or reproductive growth stages of the row crop.

2. (canceled)

3. The agricultural composition of claim 1 is between about 5 and 20 mm in diameter.

4. The agricultural composition of claim 1 has an aspect ratio of between about 1 and 3.

5. The agricultural composition of claim 1 is in the form of a sphere.

6. The agricultural composition of claim 1 is in a non-spherical form.

7. (canceled)

8. The agricultural composition of claim 1 is in the form of a tablet or a briquette.

9. The agricultural composition of claim 1 wherein the polymer layer is selected from the group consisting of polylactic acid (PLA), poly butylene adipate succinate (PBSA), polyvinyl acetate, polyvinyl alcohol, polycaprolactone, alginate, xanthan _{Q}um and a combination thereof.

10. The agricultural composition of claim 1 is configured to flow through a seed planter.

11. The agricultural composition of claim 1 is applied by a broadcast spreader.

12. (canceled)

13. The agricultural composition of claim 1 wherein the polymer is a biodegradable aliphatic polyester.

14. The agricultural composition of claim 1 wherein the polymer is polylactic acid comprising a weight averaged molecular weight of about 20 kDa to about 150 kDa.

15. The agricultural composition of claim 1, wherein the polymer layer is about 0.3 mil to about 10.0 mil thick.

16. (canceled)

17. The agricultural composition of claim 1 has a release profile of about 15-25% cumulative N release in a crop growing field by about 40 days after planting.

18. The agricultural composition of claim 1 has a release profile of about 60-90% cumulative N release in a maize growing field by about 60-90 days after planting.

19. The agricultural composition of claim 1 has a release profile of no more than about 40% cumulative N release by 40 days after planting the agricultural composition and about 60-100% cumulative N release in a maize growing field by about 60-90 days after planting.

20. (canceled)

21. (canceled)

22. (canceled)

23. (canceled)

24. (canceled)

25. (canceled)

26. (canceled)

27. The agricultural composition of claim 1 is between about 6 and 14 mm in diameter and comprises an aspect ratio of between about 1 and 3.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. A method of increasing yield of a crop in a field, the method comprising providing an agricultural composition during planting of the crop seed in the field, wherein the agricultural composition comprises
a) optionally, a fertilizer component, wherein the fertilizer component releases about 70-90 cumulative % of nitrogen between about 30-90 days into soil after planting the crop seed and comprises about 0.1 to about 0.8 grams of Nitrogen; and
b) a crop protection composition, wherein the crop protection composition is released into soil such that about 70-90 cumulative % of one or more active ingredients in the crop protection composition is available to the crop during about 20-100 days after planting the crop seed;
wherein the agricultural composition comprises a biodegradable polymer layer having a water permeability of about 1 to about 2000 g/m²/day at 25 degrees Celsius and thereby increasing the yield of the crop.

40. The method of claim 39, wherein the crop is selected from the group consisting of maize, soybean, wheat, rice, cotton, sorghum, millet and barley.

41. The method of claim 39, wherein the fertilizer component comprises a nutrient selected from the group consisting of nitrogen, phosphorus, potassium and a combination thereof.

42. The method of claim 39, wherein the agricultural composition is provided at planting of the crop seed or prior to planting the crop seed.

43. The method of claim 39, wherein the soil is classified as a soil type that has a lower water holding capacity.

44. The method of claim 39 wherein the crop protection composition is selected from the group consisting of an insecticide, a fungicide, a nematicide, biological component and a combination thereof.

45. The method of claim 39, wherein the crop protection composition is selected from the group consisting of clothianidin, thiamethoxam, chlorantraniliprole, cyantraniliprole, sulfoxaflor, imidacloprid, bifenthrin, and a combination thereof.

46. The method of claim 45, wherein the neonicotinoid insecticide is released into the soil such that an effective amount of the insecticide is present in the soil when the target pest is present in the field during later developmental stages of the crop.

47. The method of claim 45, wherein the anthranilic diamide insecticide is released into the soil such that an effective amount of about 5-60 g/hectare is present in the soil after about 20-100 days from providing the agricultural composition in the field.

48. The method of claim 39, wherein the field is characterized by the presence of one or more late season pests that target maize, soybeans, rice, wheat, sorghum, barley, millet, canola or cotton.

49. The method of claim 48, wherein the late season pest is corn root worm or fall army worm.

50. (canceled)

51. The method of claim 39, wherein the crop is maize and the yield increase in the field is about 10% to about 50% compared to a control field wherein a control fertilizer component comprising a normal release profile of nitrogen is applied, wherein both the fertilizer component and the control fertilizer component comprise substantially the same total nitrogen amount at planting.

52. (canceled)

53. The method of claim 39, wherein the crop protection composition comprises an effective amount of a pesticide that results in a reduced seed germination or reduced seedling stand or reduced crop response if the effective amount of the pesticide is applied as a seed treatment to the crop seed.

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. A method of increasing yield of a crop plant, the method comprising:
a) providing an extended release agricultural composition to a field comprising a plurality of crop plants, wherein the crop plant expresses an agronomic trait and wherein the extended release composition comprises a polymer layer that has a water permeability of about 1 to about 2000 g/m²/day at 25 degrees Celsius; and wherein the extended release composition is between about 4 and 14 mm in diameter;
b) growing the crop plant in a crop growing environment and thereby increasing the yield of the crop plant.

69. The method of claim 68, wherein the agronomic trait is a nitrogen use efficiency trait.

70. The method of claim 68, wherein the agronomic trait is an insect resistance trait.

71. (canceled)

72. (canceled)

73. (canceled)

74. The method of claim 68, wherein the agronomic trait is a disease resistance trait.

75. The method of claim 70, wherein the insect resistance trait is due to the expression of a component selected from the group consisting of Bt gene, short interfering RNA molecule targeted to a pest, heterologous non-Bt insecticidal protein, and a combination thereof.

76. The method of claim 68, wherein the crop plant is selected from the group consisting of maize, soybean, rice, wheat, sorghum, cotton, canola, alfalfa and sugarcane.

77. (canceled)

78. (canceled)

79. (canceled)

80. (canceled)

81. (canceled)

82. (canceled)

83. (canceled)

84. (canceled)

85. (canceled)

86. (canceled)

87. A method of increasing yield of a crop plant, the method comprising:
a) broadcast spreading an extended release agricultural composition to a field comprising a plurality of crop plants, wherein the extended release composition comprises a biodegradable polymer component that has a water permeability of 10 to 500 g/m²/day at 25 degrees Celsius; and wherein the extended release composition is between about 2 and 14 mm in diameter; and
b) growing the crop plant in a crop growing environment and thereby increasing the yield of the crop plant.

88. The method of claim 87, wherein the agricultural composition comprises about 0.1 to 0.8 grams of nitrogen and the polymer component is a polymer layer of about 10-250 microns thick.

89. The method of claim 87, wherein the agricultural composition comprises one or more crop protection agents selected from the group consisting of insecticides, fungicides and a combination thereof.

90. The method of claim 87, wherein the agricultural composition is an extruded bead comprising a biologically effective amount of a plurality of crop protection agents.

91. (canceled)

92. The method of claim 87, wherein the agricultural composition comprises a crop protection agent selected from the group consisting of insecticides, fungicides, nematicides, biological, safener, herbicides and a combination thereof.
